(19) United States
(12) Patent Application Publication
(10) Pub. No.: US 2017/0038825 A1
(43) Pub. Date: Feb. 9, 2017

(54) INFORMATION PROCESSING APPARATUS, INFORMATION PROCESSING SYSTEM, AND INFORMATION PROCESSING METHOD

(71) Applicant: Kazunobu Takahashi, Kanagawa (JP)

(72) Inventor: Kazunobu Takahashi, Kanagawa (JP)

(73) Assignee: Ricoh Company, Ltd., Tokyo (JP)

(21) Appl. No.: 15/224,304

(22) Filed: Jul. 29, 2016

(30) Foreign Application Priority Data
Aug. 4, 2015 (JP) 2015154311
Nov. 13, 2015 (JP) 2015223005

(51) Int. Cl. G06F 1/32; G06Q 10/06

(52) U.S. Cl. CPC G06F 1/3296; G06F 1/3206; G06Q 10/06314; G06F 9/4418

(57) ABSTRACT

An information processing apparatus capable of communicating with machines configured to operate in a first operation mode and in a second operation mode in which energy consumption is lower than the first operation mode via a network is provided. The information processing apparatus includes a processor configured to obtain from the machines data sets including a use time information item generated when the machines are used; and generate time information used for transitioning from the first operation mode to the second operation mode by calculating differences between the use time information items of the data sets for each of the machines.

### CROSS-REFERENCE TO RELATED APPLICATIONS

The present application claims the benefit of priority under 35 U.S.C. §119 of Japanese Patent Application No. 2015-154311, filed Aug. 4, 2015, and Application No. 2015-223005, filed Nov. 13, 2015, the contents of which are incorporated herein by reference in their entirety.

### BACKGROUND OF THE INVENTION

1. Field of the Invention

The present disclosure relates to an information processing apparatus, an information processing system, and an information processing method.

2. Description of the Related Art

A machine such as an information processing apparatus often has an operational mode referred to as an energy saving mode in which energy consumption can be reduced. Energy consumption can be reduced by transitioning to the energy saving mode while a user does not use the machine. Further, when the user uses the machine, it is possible for the machine to detect an operation, etc., of the user and to return to a normal mode from the energy saving mode.

It is often the case that the user does not use the machine at night, and thus, a technique is proposed in which it is possible to set a period when the machine is in an energy saving mode (e.g., refer to Patent Document 1). Patent Document 1 describes a server configured to, in the case where there are a plurality of the machines, set periods of the machines in which the machines are in an energy saving mode in such a way that the periods do not overlap each other.

However, there is a problem for the server described in Patent Document1 in which it is not possible for the server to set individual timings of image forming apparatuses to assume an energy saving mode. The problem will be further described below.

First, the machine has, not only a function in which a user can set a schedule of energy saving mode, but also a function in which the machine automatically transitions to an energy saving mode when a state of no use continues. Time from an end of use of the machine to transition to an energy saving mode is referred to as a “standby time”, which can be set in each machine by the user.

Therefore, each machine automatically transitions to an energy saving mode when a state of no use continues. However, in order to increase an effect of energy saving by transitioning to an energy saving mode, it is required that an appropriate standby time is set. For example, in the case where time of no use is long, the effect of energy saving is increased when standby time is short because transition to an energy saving mode occurs early, and standby power is wastefully consumed when standby time is long.

On the other hand, in the case where time of no use is short, the effect of energy saving is increased when standby time is long because the longer the standby time, the less often transition to an energy saving mode occurs and energy consumption for returning to a normal mode is saved. And the effect of energy saving is decreased when standby time is too short because even if transition to an energy saving mode occurs quickly, energy for returning to a normal mode is also consumed quickly.

As described above, in order to increase an effect of energy saving by transition to an energy saving mode, it is preferable to set an appropriate standby time. However, conventionally, it is difficult to set an appropriate standby time for each machine.

In view of the above, an object of the present disclosure is to provide an information processing apparatus that is capable of individually setting a timing for a machine to transition to an energy saving mode.

### CITATION LIST

### Patent Document

[Patent Document 1] Japanese Unexamined Patent Application No. 2014-78269

### SUMMARY OF THE INVENTION

An information processing apparatus capable of communicating with machines configured to operate in a first operation mode and in a second operation mode in which energy consumption is lower than the first operation mode via a network is provided. The information processing apparatus includes a data obtaining unit configured to obtain from the machines data sets including a use time information item generated when the machines are used; and a time information generation unit configured to generate time information used for transitioning from the first operation mode to the second operation mode by calculating differences between the use time information items of the data sets for each of the machines.

An information processing apparatus that is capable of individually setting a timing for a machine to transition to an energy saving mode can be provided.

Other objects, features and advantages of the present invention will become more apparent from the following detailed description when read in conjunction with the accompanying drawings.

### BRIEF DESCRIPTION OF THE DRAWINGS

FIG. 1 is an example of a drawing illustrating an overall operation of a machine system.

FIG. 2 is an example of a configuration diagram of the machine system.

FIG. 3 is an example of a hardware configuration diagram of a server.

FIG. 4 is an example of a hardware configuration diagram of an image forming apparatus.

FIG. 5 is an example of a functional block diagram of the machine system.

FIG. 6 is an example of a sequence diagram illustrating a procedure of setting a standby time in an image forming apparatus of a customer by operating an administrator PC by an administrator.

FIG. 7 is an example of a sequence diagram illustrating a procedure of setting a standby time in an image forming apparatus operated by the administrator.

FIG. 8 is an example of a drawing illustrating a method of generating an intermediate data table.

FIG. 9 is a drawing illustrating an example of a calculation condition setting screen displayed on a display of the administrator PC.

FIG. 10 is an example of a flowchart illustrating a procedure of calculating a standby time by the server.

FIG. 11 is an example of a flowchart illustrating a procedure of resizing the intermediate data table by a resizing unit.

FIG. 12 is a drawing illustrating a calculation of a standby time by using a calendar.

FIG. 13 is an example of a flowchart illustrating a procedure of obtaining log data by a time calculation unit by using a calendar.

FIGS. 14A and 14B are examples of drawings illustrating a verification of a calculation method based on a calculated standby time.

FIG. 15 is an example of a flowchart illustrating a procedure of selecting a standby time by a selection unit.

FIG. 16 is an example of a drawing illustrating an overall operation of the machine system (embodiment 2).

FIG. 17 is an example of a functional block diagram of the machine system (embodiment 2).

FIG. 18 is a drawing illustrating an example of a calculation condition setting screen displayed on a display of the administrator PC (embodiment 2).

FIGS. 19A and 19B are examples of drawings illustrating generation of a daily energy consumption table.

FIG. 20 is an example of a flowchart illustrating a procedure of calculating energy consumption by an energy consumption calculation unit and registering the results in the daily energy consumption table.

FIG. 21 is an example of a flowchart illustrating a procedure of setting an optimal standby time for a customer by a server.

### DETAILED DESCRIPTION OF THE PREFERRED EMBODIMENTS

In the following, embodiments of the present disclosure will be described referring to accompanying drawings.

### Embodiment 1

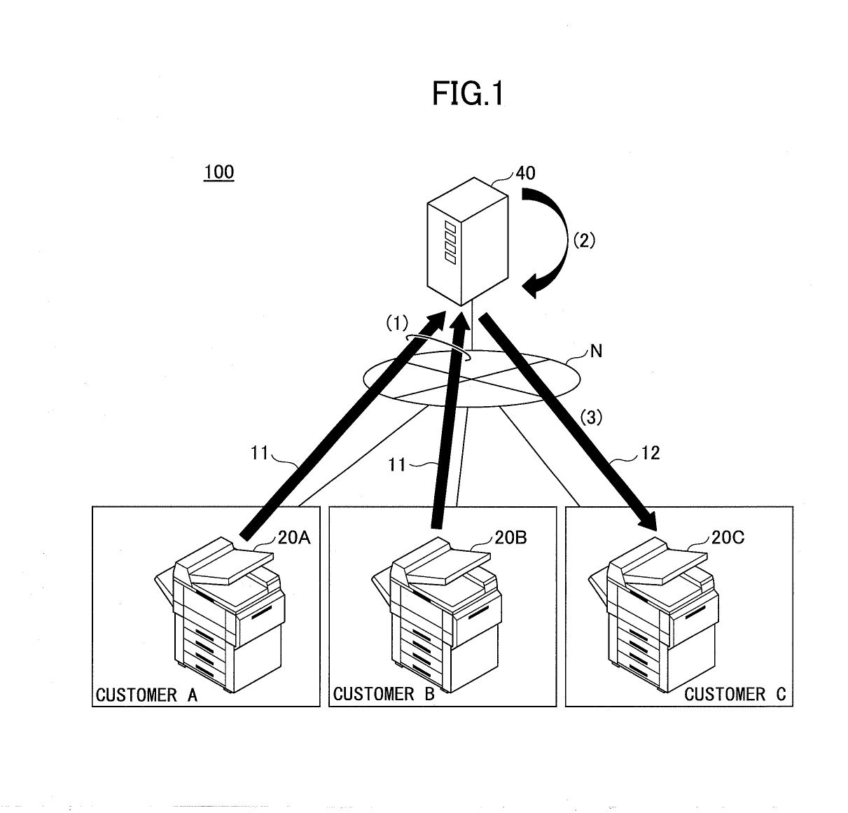

FIG. 1 is an example of a drawing illustrating an overall operation of a machine system 100 according to an embodiment. A server 40 and a plurality of image forming apparatuses 20A through 20C (referred to as image forming apparatus 20 in the case where the individual image forming apparatuses are not distinguished) are connected to each other and capable of communicating with each other via a network N. For the sake of convenience, it is assumed that an image forming apparatus 20A of a customer A and an image forming apparatus 20B of a customer B have been previously installed respectively at the customer A and the customer B, and an image forming apparatus 20C of a customer C is going to be installed or has been installed at the customer C recently.

(1) The image forming apparatuses 20A and 20B periodically transmit log data 11 to the server 40. The log data 11 includes at least printing-date-and-time (use time) of the image forming apparatuses 20A and 20B.
(2) The server 40 statistically processes intervals of printing-date-and-time data items included in the log data 11, and calculates an optimal standby time 12 (an example of time information).
(3) The server 40 transmits the standby time 12 to the image forming apparatus 20C, and an appropriate standby time is set in the image forming apparatus 20C.

It is known that the appropriate standby time has a tendency depending on customer size or business of a customer. The server 40 classifies the log data 11 according to customer size or business of the customer C, and calculates the standby time. Therefore, it is possible for the image forming apparatus 20C to transition to an energy saving mode with a standby time optimized for the customer size or the type of business from the beginning of installation of the image forming apparatus 20C.

<Terminology>

Terms used in an embodiment will be described.

The standby time is a time from the last time the image forming apparatus 20 has been used to when the image forming apparatus 20 transitions to an energy saving mode.

The image forming apparatus 20 has at least two modes including a normal mode (a first mode) in which normal energy is consumed for use of a user and an energy saving mode (a second mode) in which energy consumption is reduced compared with the normal mode because the image forming apparatus 20 is not used by a user.

A customer is a user of the image forming apparatus 20. It does not matter whether the image forming apparatus 20 is purchased or rented (leased).

A use time is a time when the image forming apparatus 20 is used by a user. Specifically, printing-date-and-time can be listed as an example of the use time. In the case where a scanner of the image forming apparatus 20 is used, a scan time may be a use time. In the case where a FAX function of the image forming apparatus 20 is used, a FAX transmission time or a FAX reception time may be a use time.

Log data is data in which use situation of a machine is recorded. What kind of information is included in the log data depends on the machine. In the case of the image forming apparatus 20, the log data includes, but is not limited to, an execution time of job, a type of job, the number of copies, use amount (accumulated number of printing), remaining amount of expendables, a job condition, etc. Any information may be included as log data as long as the information is obtainable by the image forming apparatus 20. In the description of the present embodiment, it is assumed that the use time is printing-date-and-time recorded as an execution time of print job, and the log data includes the printing-date-and-time.

<System Configuration Example>

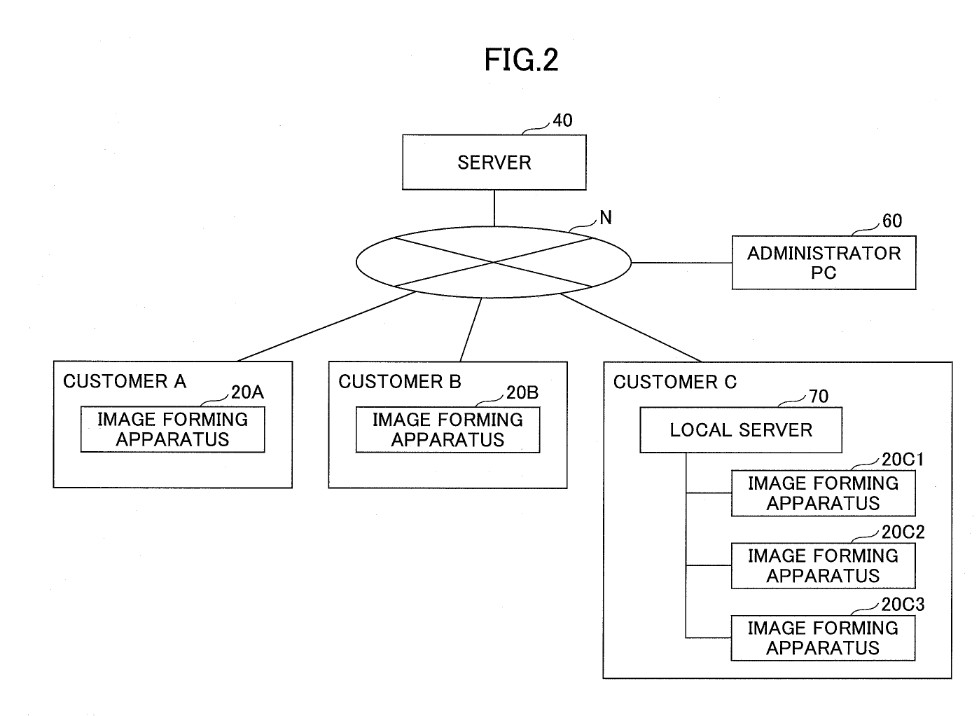

FIG. 2 is an example of a configuration diagram of the machine system 100. The machine system 100 is an example of an information processing system. A method of information processing performed by the machine system 100 is referred to as an information processing method.

The server 40, the administrator PC 60, the image forming apparatus 20 or a local server 70 used by a customer are connected to each other via the network N.

The server 40 is a kind of an information processing apparatus, and it is preferable that the server 40 is adapted to cloud computing. A physical configuration of the cloud computing is not strictly defined. The configuration and installation location of the information processing apparatus may be flexibly changed by dynamically connecting and disconnecting resources such as a CPU, a RAM, and a storage included in the information processing apparatus depending on the processing load. Further, typically, the server 40 is virtualized in the cloud computing. According to the virtualization, it is possible for an information processing apparatus to provide functions of a plurality of the servers 40, and it is possible for a plurality of information processing apparatuses to provide a function of a single server 40. It should be noted that it is possible that the server 40 may be provided, not by the cloud computing, but by a single information processing apparatus.

The customers A through C are a corporation, a natural person, an organization, an individual, etc., by which the image forming apparatus 20 is used. There is a case in which the customer is referred to as a tenant, which is used to indicate that the customer rents a resource of the server 40. As an example of a customer, a company, a government office, a corporation, a foundation, a school corporation, a religious corporation, an office, a non-profit organization (NPO), etc., may be listed, which is not limited. For example, in the case where the customer is a company, a type of business may vary.

Further, there is a case where a single customer has multiple offices (plants, factories, branch offices). For example, there is a case where a large plant is treated as a customer. A plant may be regarded as a customer or regarded as an office depending on a contract of a tenant, which can be set by an administrator, etc., of the machine system 100.

The image forming apparatus 20 is an example of a machine which is used by a customer and has an energy saving mode and a normal mode. The image forming apparatus 20 may be purchased or rented (leased). The image forming apparatus 20 may have a function as a printer that mainly performs printing. The image forming apparatus 20 may have one or more functions of a scanner function, a copier function, and a FAX function. This kind of image forming apparatus 20 is referred to as a complex machine or a multi-function peripheral (MFP). Effect of energy saving by the energy saving mode is high in a printer function in which a fixing unit is used, in a copy function, or in a reception function of FAX functions. An embodiment will be described by using log data which is created when mainly a printer function or a copy function is used. However, transition to an energy saving mode and a normal mode may be performed for a scanner function or a FAX function. In this case, calculation of standby time based on the log data is performed for a scanner function or a FAX function.

As a machine, other than the image forming apparatus 20, a projector, a video conference terminal, an electronic whiteboard, a personal computer (PC), a smartphone, a tablet apparatus, a wearable PC (e.g., a heads up display, a watch), etc., may be listed, which is not limited.

Further, in the customer C, a plurality of the image forming apparatuses 20C1, 20C2, and 20C3 are connected to, and capable of communicating with, a local server 70. A LAN, USB connection, Bluetooth (registered trademark), ZigBee (registered trademark), infrared communication, etc., may be used for the communications, which is not limited. The local server 70 collects log data from the image forming apparatus 20 and transmits the log data to the server 40 according to a predetermined schedule. It should be noted that the local server 70 may not be included. In this case, each of the image forming apparatuses 20 transmits the log data generated by the image forming apparatus 20 to the server 40 according to a predetermined schedule. Further, the local server 70 may be represented by any one of the image forming apparatuses 20. In this case, an independent local server 70 is not needed, and the image forming apparatus 20 representing the local server 70 is responsible for the function of the local server 70.

Further, the administrator PC 60 connected to the network N is a terminal (an example of a terminal apparatus) used by an administrator of a customer or the machine system 100. The administrator of the customer uses the administrator PC to set a standby time in the image forming apparatus 20 installed for the customer the administrator belongs to. The administrator of the machine system 100 sets the standby time in the image forming apparatus 20 installed for any one of the customers. In the following description, it is assumed that the administrator PC 60 is used by mainly the administrator of the customer.

The administrator PC 60 communicates with the server 40 and requests the server 40 to calculate the standby time to be set in the image forming apparatus 20 of the customer. The server 40 sets the standby time in the image forming apparatus 20 of the customer. Further, the administrator can request calculation of the standby time, other than by using the administrator PC 60, by using the image forming apparatus 20. In this case, the image forming apparatus 20 used by the administrator receives setting of the standby time from the server 40.

It should be noted that the network N includes at least one of a LAN installed in the facility such as an office of the customer, a provider's network that connects the LAN to the Internet, lines provided by a telecommunications carrier, etc. In the case where the image forming apparatus 20 is directly connected to a telecommunications network or a mobile telephone network, the image forming apparatus 20 can be connected to the provider's network without going through the LAN. In the case where the cloud computing is used, the network N may include the Internet. The network N may include a wired network, a wireless network, or a combination thereof.

<<Hardware Configuration>>

(Hardware Configuration of Server 40)

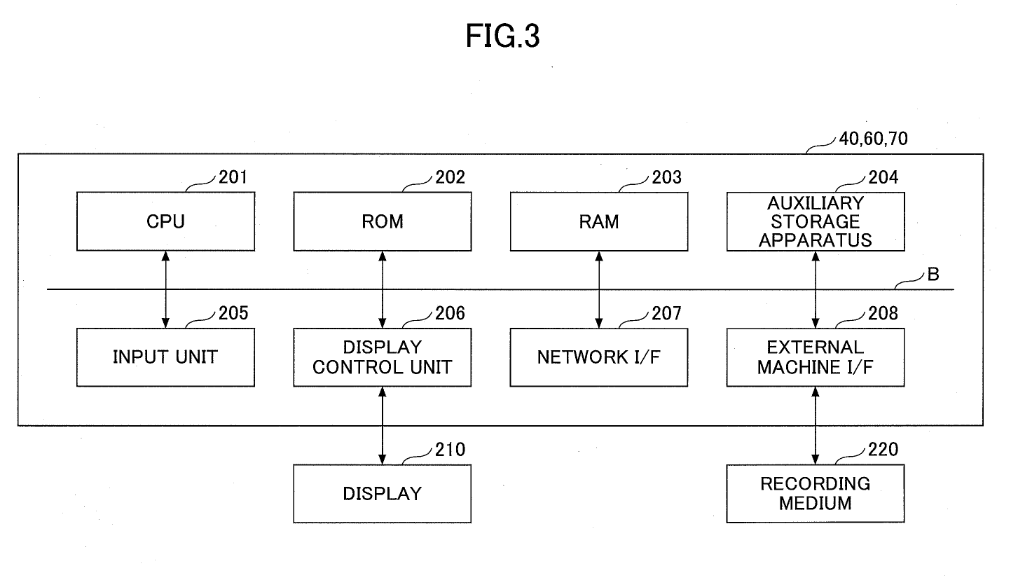

Next, referring to FIG. 3, a hardware configuration of the server 40, the administrator PC 60, and the local server 70 will be described. FIG. 3 is an example of a hardware configuration diagram of the server 40. The server 40 includes a central processing unit (CPU) 201, a read only memory (ROM) 202, a random access memory (RAM) 203 and an auxiliary storage apparatus 204. Further, the server 40 includes an input unit 205, a display control unit 206, a network I/F 207, and an external machine I/F 208. It should be noted that the units of the server 40 are connected to each other via a bus B. Therefore, the server 40 has functions as the information processing apparatus.

The CPU 201 executes various programs, an operating system (OS), etc., stored in the auxiliary storage apparatus 204. The ROM 202 is a non-volatile memory. The ROM 202 stores programs, data, etc., which are needed for the CPU 201 to execute the programs stored in the auxiliary storage apparatus 204.

The RAM 203 is a main memory apparatus including a dynamic random access memory (DRAM), an static random access memory (SRAM), or the like. The programs stored in the auxiliary storage apparatus 204 are read into the RAM 203 and executed by the CPU 201. The RAM 203 is used as a work area of the CPU 201.

The auxiliary storage apparatus 204 stores various kinds of programs (e.g., a server program 4010 which will be described later) executed by the CPU 201, and various kinds of databases used when the CPU 201 executes the programs. The auxiliary storage apparatus 204 is a non-volatile memory including a hard disk drive (HDD), a solid state drive (SSD), etc. It should be noted that the databases will be described later.

The input unit 205 is an interface for an operator to input various kinds of instructions to the server 40. For example, the input unit 205 is a keyboard, a mouse, a touch panel, a voice-input apparatus, etc.

The display control unit 206 displays various kinds of information items in the server 40 on a display 210 in various forms such as a cursor, a menu, a window, a character, or an image, according to a request from the CPU 201. The display control unit 206 is, for example, a graphic chip or a display I/F.

The network I/F 207 is a communication apparatus for communicating with the image forming apparatus 20 and the administrator PC 60 via the network N. The network I/F 207 is, for example, but is not limited, an Ethernet (registered trademark) card.

The external machine I/F 208 is an interface for connecting a USB cable, or various kinds of recording medium 220 such as a USB memory.

The hardware configuration of the server 40 illustrated in the figure indicates hardware elements the server 40 preferably have. However, it is not necessary for the hardware elements to be contained in a single housing or included in a single apparatus.

It should be noted that it is assumed that the administrator PC 60 and the local server 70 have a similar hardware configuration as the server 40. It is not necessary for the administrator PC 60 and the local server 70 to have exactly the same hardware configuration as the server 40. There will be no problem in describing an embodiment even if there are some differences.

(Hardware Configuration of Image Forming Apparatus)

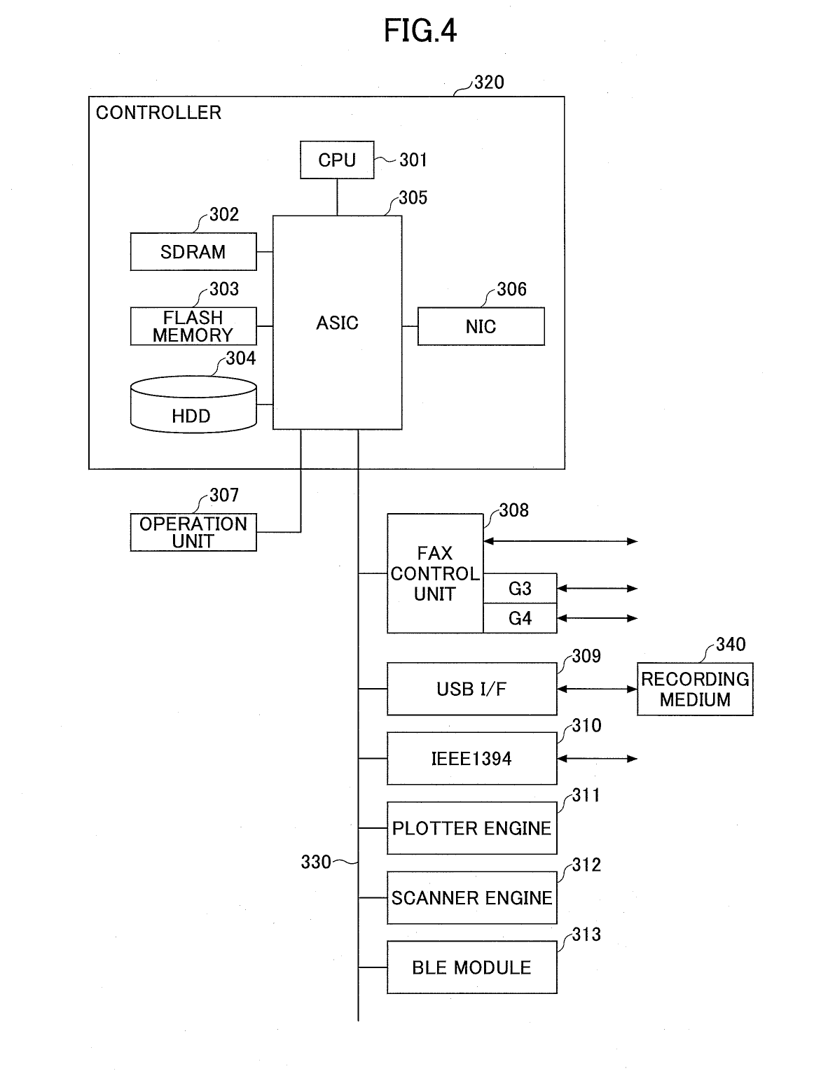

FIG. 4 is an example of a hardware configuration diagram of the image forming apparatus 20. The image forming apparatus 20 also has functions as an information processing apparatus (corresponding to second information processing apparatus). The image forming apparatus 20 includes a controller 320. The controller 320 includes a CPU 301, an application specific integrated circuit (ASIC) 305, a SDRAM 302, a flash memory 303, a HDD 304, and a network interface card (NIC) 306.

The ASIC 305 is a multi-function device board including a CPU interface, a SDRAM interface, a local bus interface, a PCI bus interface, a media access controller (MAC), a HDD interface, etc.

The CPU 301 reads various kinds of programs (e.g., a use management program) from the HDD 304 via the ASIC 305 and executes the programs.

The SDRAM 302 functions as a program memory for storing the programs, or a work memory used by the CPU 301 when the CPU 301 executes the programs. It should be noted that the SDRAM 302 may be replaced by a DRAM or a SRAM.

The flash memory 303 is a non-volatile memory, and stores a boot loader (boot program) for starting the image forming apparatus 20, or an OS. Further, the flash memory 303 functions as an application memory for storing programs. Further, the flash memory 303 functions as a service memory for storing software of various services (copy service, print service, facsimile service). Further, the flash memory 303 functions as a firmware memory for storing firmware, and a data memory for storing a network address, model information, etc.

It should be noted that the flash memory 303 may be replaced by a non-volatile RAM in which a RAM and a backup circuit with battery are integrated, or other non-volatile memories including an electrically erasable programmable read-only memory (EEPROM), etc.

The HDD 304 is a non-volatile recording medium in which data is retained regardless of ON/OFF of the power supply of the image forming apparatus 20. The HDD 304 stores programs and data other than the programs and data stored in the flash memory 303. It should be noted that the HDD 304 may be used as a firmware memory.

The NIC 306 is an interface for communicating with the server 40 via the network N (e.g., Ethernet (registered trademark) card).

An operation unit 307 is connected to the controller 320. The operation unit 307 includes various kinds of operation keys, a character display device of a liquid crystal display (LCD) or a CRT as a display apparatus, and a touch panel, and is used by a user when inputting various kinds of instructions to the image forming apparatus 20.

Further, a fax control unit 308, a USB I/F 309 capable of attaching and detaching a recording medium 340, an IEEE1394 310, a plotter engine 311, a scanner engine 312, and a BLE module 313 are connected to the controller 320 via a PCI bus 330. With the above arrangement, the image forming apparatus 20 can provide various services including a copy service, a print service, a facsimile service, etc. The plotter engine 311 may employ an electrophotography method or an inkjet method. It should be noted that the BLE module 313 performs communications using Bluetooth (registered trademark).

It should be noted that the configuration illustrated in the figures is just an example. The hardware configuration of the image forming apparatus 20 is not limited to what is illustrated in FIG. 4. For example, the NIC 306 may be connected to the PCI bus 330. Further, the NIC 306 may be connected to the network N via a wire, or may be wirelessly connected to the network N by using a wireless LAN, etc.

Further, the NIC 306 may be replaced by, or may be used with, a digital service unit (DSU) or a modem for connecting to a telephone network. A communication apparatus for connecting to a mobile telephone network may be included.

<Functions>

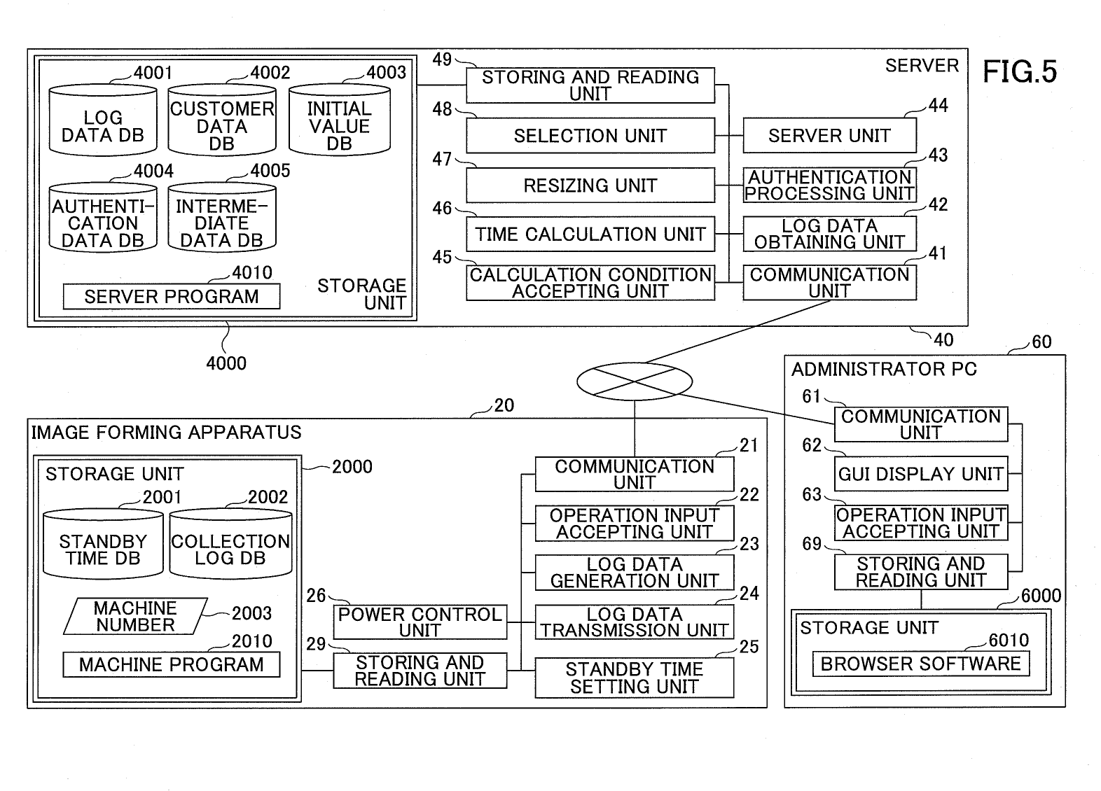

FIG. 5 is an example of a functional block diagram of the machine system 100. In the following, the server 40 and the image forming apparatus 20 will be described. It should be noted that the local server 70 according to an embodiment relays the log data. Functions of the local server 70 will be described as needed.

<<Image Forming Apparatus>>

The image forming apparatus 20 includes a communication unit 21, an operation input accepting unit 22, a log data generation unit 23, a log data transmission unit 24, a standby time setting unit 25, a power control unit 26, and a storing and reading unit 29. The above units are functions or means which are realized by any of the elements illustrated in FIG. 4 which operates according to instructions from CPU 301 which operates according to a machine program 2011 stored in the HDD 304 or the SDRAM 302.

Further, the image forming apparatus 20 has a storage unit 2000 including one or more of the HDD 304, the flash memory 303 and the SDRAM 302 illustrated in FIG. 4. In the storage unit 2000, a standby time DB 2001, a collection log DB 2002, a machine number 2003, and a machine program 2010 are stored.

The machine number 2003 is identification information for uniquely identifying the image forming apparatus 20 in the machine system 100. The machine number 2003 includes a language, a character, a symbol, various kinds of marks, etc. Further, a combination of at least two of the language, character, symbol, and marks may be included in the machine number 2003.

The machine number 2003 includes a model number or is associated with a model number. The model number is related to model classification of the image forming apparatus 20. Functions of an image forming apparatus 20 are approximately determined by the model number. For example, which functions of a printer function, a scanner function, a copy function and a FAX function are included in the image forming apparatus 20, etc., can be determined according to the model number. In the description of an embodiment, it is assumed that the machine number 2003 does not include the model number in order to avoid the machine number 2003 to be redundant. In other words, the machine number 2003 is associated with the model number. The model number can be determined from the machine number 2003 and the machine number 2003 can be determined from the model number.

The machine program 2010 may be distributed in a state where the machine program 2010 is stored in a recording medium 340, or may be downloaded from a program providing server.

In the following, the various kinds of databases stored in the storage unit 2000 will be described.

TABLE 1
STANDBY TIME TABLE

| TIME ZONE | STANDBY TIME |
|---|---|
| 8 O’CLOCK TO 12 O’CLOCK | T₁ MINUTES |
| 12 O’CLOCK TO 13 O’CLOCK | T₂ MINUTES |
| 13 O’CLOCK TO 17 O’CLOCK | T₃ MINUTES |
| 17 O’CLOCK TO 21 O’CLOCK | T₄ MINUTES |
| 21 O’CLOCK TO 8 O’CLOCK | T₅ MINUTES |

The storage unit 2000 includes the standby time DB 2001 in which a standby time table illustrated in Table 1 is stored. In the standby time table, “standby time is associated with time zone”. It is possible to set a different standby time for a different time zone, which tends to improve the energy saving effect. It should be noted that standby times T₁ minutes through T₅ minutes do not necessarily mean different times. Rather, the same standby time may be registered. Further, the size of the suffix numbers 1 through 5 has nothing to do with the length of the standby time.

TABLE 2
COLLECTION LOG DATA TABLE
PRINTING-DATE-AND-TIME
2014/04/01 10:30
2014/04/01 10:38
2014/04/01 10:52
.
.
.

The storage unit 2000 includes the collection log DB 2002 in which a collection log data table illustrated in Table 2 is stored. The collection log data table includes an item “printing-date-and-time”. The printing-date-and-time (corresponding to the above-described execution time of job) is date and time of print job execution (start of execution, or end of execution) set by the user of the image forming apparatus 20. As described above, the log data may include the number of copies, etc., other than “printing-date-and-time”. However, for the sake of description convenience, an example will be described in which “printing-date-and-time” is included as the log data. The collection log DB 2002 is an example of a data accumulation means.

(Functions of MFP)

The communication unit 21 is realized by the CPU 301, NIC 306, etc., illustrated in FIG. 4, and performs various kinds of communications such as transmitting the log data to the server 40, receiving the standby time from the server 40, etc. Information communicated by the communication unit 21 is not limited to the above example. The communication unit 21 is an example of a transmission means.

The operation input accepting unit 22 is realized by the CPU 301, the operation unit 307, etc., illustrated in FIG. 4, and accepts operations from the user. Further, the operation input accepting unit 22 displays a graphical user interface (GUI) on the operation unit 307, and accepts a key-press of a soft key included in the GUI.

The log data generation unit 23 is realized by the CPU 301, etc., illustrated in FIG. 4, and generates the log data every time the user of the image forming apparatus 20 uses the printer function of the image forming apparatus 20. The generated log data is stored in the collection log DB 2002.

The log data transmission unit 24 is realized by the CPU 301, etc., illustrated in FIG. 4, and transmits the log data to the server 40 in response to a state change in which a time set in the image forming apparatus 20 has arrived, or load of the image forming apparatus 20 has become low. The machine number 2003 is added to the log data. In the case where the log data transmission time is set in the image forming apparatus 20, it is preferable that the transmission time is adjusted in such a way that the log data transmission from the image forming apparatuses 20 to the server 40 is not concentrated. Alternately, the image forming apparatus 20 may transmit the log data in response to reception of a transmission request from the server 40. It should be noted that any communication protocol may be used. For example, the log data may be transmitted by using a protocol including HTTP, simple network management protocol (SNMP), etc.

The standby time setting unit 25 is realized by the CPU 301, etc., illustrated in FIG. 4, and sets the standby time transmitted from the server 40 in the standby time DB 2001.

The power control unit 26 is realized by the CPU 301, etc., illustrated in FIG. 4, and causes the image forming apparatus 20 to transition from a normal mode to an energy saving mode in the case where a state in which the image forming apparatus 20 is not performing a job related process has continued for the standby time. Further, the power control unit 26 causes the image forming apparatus 20 to transition from an energy saving mode to a normal mode in the case where the image forming apparatus has received a job execution request (a print job from a PC, an operation of the operation unit 307, setting of a document for copying). The power control unit 26 operates not only in a normal mode but also in an energy saving mode.

The storing and reading unit 29 is realized by the HDD 304, the flash memory 303, the SDRAM 302, etc., illustrated in FIG. 4, and performs a process of storing various types of data items in the storage unit 2000, and reading the data items stored in the storage unit 2000.

<<Server 40>>

The server 40 includes a communication unit 41, a log data obtaining unit 42, an authentication processing unit 43, a server unit 44, a calculation condition accepting unit 45, a time calculation unit 46, a resizing unit 47, a selection unit 48, and a storing and reading unit 49. The above units are functions or means which are realized by any of the elements illustrated in FIG. 3 which operates according to instructions from the CPU 201 which operates according to the server program 4010 stored in the auxiliary storage apparatus 204 or the RAM 203.

Further, the server 40 has a storage unit 4000 including one or more of the auxiliary storage apparatus 204, the RAM 203, and the ROM 202 illustrated in FIG. 3. In the storage unit 4000, a log data DB 4001, a customer DB 4002, an initial value DB 4003, an authentication DB 4004, an intermediate data DB 4005, and the server program 4010 are stored. It should be noted that the server program 4010 may be distributed in a state where the server program 4010 is stored in a recording medium 220, or may be downloaded from the program providing server.

In the following, the various kinds of databases stored in the storage unit 4000 will be described.

TABLE 3
LOG DATA TABLE

| MACHINE NUMBER | PRINTING-DATE-AND-TIME |
|---|---|
| A | 2014/04/01 10:30 |
| A | 2014/04/01 10:38 |
| A | 2014/04/01 10:52 |
| B | 2014/04/01 10:35 |
| B | 2014/04/01 10:40 |
| C | 2014/04/01 10:32 |
| . | . |
| . | . |
| . | . |

The storage unit 4000 includes the log data DB 4001 in which a log table illustrated in Table 3 is stored. The log table includes items “machine number” and “printing-date-and-time”. The “printing-date-and-time” is the same as what is stored in the collection log table. Further, the machine number is what is added to the log data by the image forming apparatus 20. The server 40 can identify the image forming apparatus 20 by using the machine number.

TABLE 4
CUSTOMER DATA TABLE

| | | | NUMBER OF | MACHINE | |
|---|---|---|---|---|---|
| CUSTOMER | CUSTOMER | TYPE OF | EMPLOYEES | NUMBER | |
| ID | SIZE | BUSINESS | PER MFP | (NAME) | |
| 001 | S | 05 | G1 | A | (MFP1) |
| 002 | M | 06 | G2 | B | (LP10) |
| 003 | L | 09 | G3 | C | (LP4) |

| | | | | |
|---|---|---|---|---|
| . | . | . | . | . |
| . | . | . | . | . |
| . | . | . | . | . |

The storage unit 4000 includes the customer data DB 4002 in which a customer data table illustrated in Table 4 is stored. The customer data table includes items “customer ID”, “customer size”, “type of business”, “the number of employees per MFP”, and “machine number”. The customer data DB 4002 is an example of a user information storage unit. The customer ID is information used for uniquely identifying a customer.

The customer size is a size of a customer in terms of the number of employees, capital, an amount of sales, etc., which is represented by S (small), M (medium), L (large), LL (very large), etc., (examples of size information).

The type of business is a business (restaurant, finance, construction, etc.,) to which the customer belongs, and is represented by codes (business type information) from 01 to 99.

The number of employees per MFP is a number obtained by dividing the number of customer employees by the number of the image forming apparatuses 20 (the number of users). For example, the number of employees per MFP is represented by five levels G1 through G5.

G1: 1 to 5 employees, G2: 6 to 10 employees, G3: 11 to 15 employees, G4: 16 to 20 employees, G5: equal to or more than 21 employees

As described above, the customer size, the type of business, and the number of employees per MFP are registered in the customer data DB 4002, and thus, it is possible for the server 40 to calculate the standby time for a customer who uses a newly installed image forming apparatus 20 according to the customer size, the type of business, or the number of employees per MFP of the customer.

The machine numbers indicate the image forming apparatuses 20 which are used by a customer (an example of machine identification information). Therefore, the number of the machine numbers is not limited to be one for one customer. The number of the machine numbers may be plural for one customer. Characters included in the parentheses of the machine number indicate a name of the image forming apparatus 20. It is possible for an administrator to determine which image forming apparatus 20 of the customer based on the name. Therefore, the name may be overlapped with a name of another customer.

The storage unit 4000 includes the initial value DB 4003 in which an initial value data table illustrated in Table 5 is stored. The initial value data table includes items “machine number”, “time zone”, and “standby time”. In other words, the standby time for each time zone calculated for the image forming apparatus 20 (machine number) by the server 40 is stored in the initial value data table.

The standby time is transmitted to the image forming apparatus 20 of the customer, and thus, it is not necessary for the server 40 to retain the standby time. However, when the server 40 retains the standby time, it is possible for the image forming apparatus 20 to obtain the standby time from the server 40 without re-calculation.

TABLE 6
AUTHENTICATION DATA TABLE

| CUSTOMER | ADMINISTRATOR | |
|---|---|---|
| ID | ID | PASSWORD |
| 001 | 001-1 | 0101 |
| 002 | 002-1 | 0202 |
| 003 | 003-1 | 0303 |
| . | . | . |
| . | . | . |
| . | . | . |

The storage unit 4000 includes the authentication data DB 4004 in which an authentication data table illustrated in Table 6 is stored. The authentication data table includes items “customer ID”, “administrator ID”, and “password”. The administrator operates the administrator PC 60 and inputs the administrator ID and the password. With the above operation, it is possible for the server 40 to identify the customer ID of a customer to which the administrator belongs.

TABLE 7
INTERMEDIATE DATA TABLE

| CUSTOMER | REPRESENTATIVE | PRINTING |
|---|---|---|
| ID | TIME | INTERVAL |
| 001 | 14 O’CLOCK | 2 MINUTES |
| 001 | 14 O’CLOCK | 3 MINUTES |
| 001 | 14 O’CLOCK | 4 MINUTES |
| 002 | 14 O’CLOCK | 5 MINUTES |
| 002 | 14 O’CLOCK | 7 MINUTES |
| 002 | 14 O’CLOCK | 10 MINUTES |
| 002 | 14 O’CLOCK | 15 MINUTES |
| 003 | 14 O’CLOCK | 5 MINUTES |
| 003 | 14 O’CLOCK | 5 MINUTES |
| 003 | 14 O’CLOCK | 7 MINUTES |
| 003 | 14 O’CLOCK | 4 MINUTES |
| . | . | . |
| . | . | . |
| . | . | . |

The storage unit 4000 includes the intermediate data DB 4005 in which an intermediate data table illustrated in Table 7 is stored. The intermediate data table includes items “customer ID”, “representative time”, and “printing interval”. The intermediate data table is a table generated for making the standby time calculation easy. All of the differences between the printing-date-and-time data items of all of the log data for all customers are registered as print intervals in the intermediate data table. Therefore, the size of the intermediate data table tends to become big, and thus, the intermediate data table is resized accordingly as described later. Further, in the intermediate data table, a representative time (when printing-date-and-time is 10:35, the representative time is “10 o'clock”) is recorded for each record. The printing-date-and-time may be recorded as it is. The intermediate data DB 4005 is an example of a data storage unit.

(Functions of Server 40)

The communication unit 41 is realized by the CPU 201, the network I/F 207, etc., illustrated in FIG. 3, and performs various kinds of communications such as receiving the log data from the image forming apparatuses 20, transmitting the standby time to the image forming apparatuses 20. Information communicated by the communication unit 41 is not limited to the above example.

The log data obtaining unit 42 is realized by the CPU 301, etc., illustrated in FIG. 3, and stores the log data obtained from the image forming apparatuses 20 in the log data DB 4001. The log data obtaining unit 42 is an example of a data obtaining means.

The authentication processing unit 43 is realized by the CPU 301, etc., illustrated in FIG. 3, and authenticates the administrator by determining whether the administrator ID and the password transmitted from the administrator PC 60 or the image forming apparatus 20 are registered in the authentication data DB 4004. The authentication processing unit 43 may ask an authentication server to perform this kind of authentication. Further, the authentication by using the administrator ID and the password is just an example. The authentication may be performed by using a PIN number, which is obtained by the image forming apparatus 20 by reading an IC card, transmitted from the image forming apparatus 20, or by using biometric authentication information.

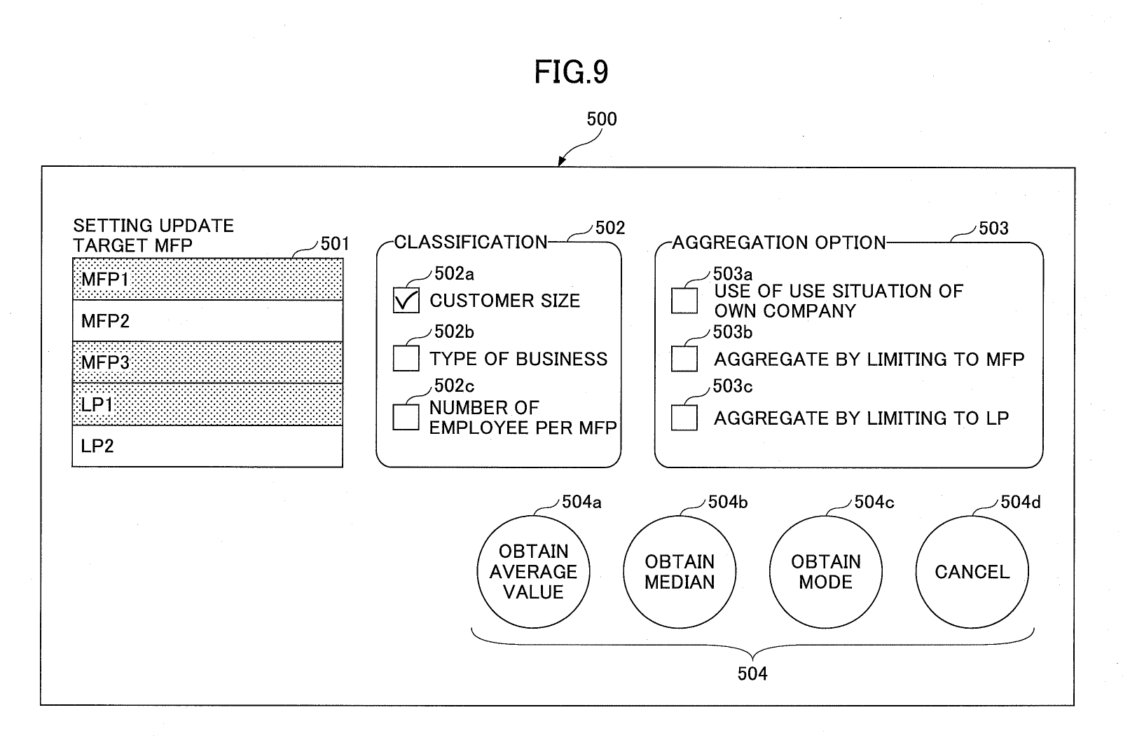

The server unit 44 is realized by the CPU 201, etc., illustrated in FIG. 3, and operates as a Web server or a Web application for the administrator PC 60. In other words, the server unit 44 provides a server function, and, in response to a HTTP/HTTPs request of the administrator PC 60, generates and transmits HTML data. A calculation condition setting screen displayed according to the HTML data will be described by referring to FIG. 9.

The calculation condition accepting unit 45 is realized by the CPU 201, etc., illustrated in FIG. 3, and accepts a standby time calculation condition transmitted from the administrator PC 60 or the image forming apparatus 20. The detailed description of the calculation condition will be provided by referring to FIG. 9. The calculation condition accepting unit 45 is an example of an extract condition information obtaining means, and the calculation condition is an example of extract condition information.

The time calculation unit 45 is realized by the CPU 201, etc., illustrated in FIG. 3, and calculates the standby time according to the standby time calculation condition. Further, the time calculation unit 46 registers the customer ID, the representative time, and the printing interval in the intermediate data table when the log data is transmitted. The time calculation unit 46 calculates the standby time by aggregating the printing intervals. “Aggregating” means calculating a standby time which is considered to reduce the energy consumption, from a plurality of the printing intervals according to a calculation method which will be described later. The time calculation unit 46 is an example of a time information generating means.

The resizing unit 47 is realized by the CPU 201, etc., illustrated in FIG. 3, and resizes the intermediate data table. The resizing unit 47 is an example of a deleting means.

The selection unit 48 is realized by the CPU 201, etc., illustrated in FIG. 3, and selects a standby time preferable for reducing the energy consumption from the standby times calculated by different calculation methods. The selection unit 48 is an example of an energy consumption calculation means.

The storing and reading unit 49 is realized by the ROM 202, the RAM 203, the auxiliary storage apparatus 204, etc., illustrated in FIG. 3, and performs a process of storing various type of data sets in the storage unit 4000, and reading the data sets stored in the storage unit 4000. The storing and reading unit 49 is an example of a reading means.

<<Administrator PC 60>>

The administrator PC 60 includes a communication unit 61, a GUI display unit 62, an operation input accepting unit 63, and a storing and reading unit 69. The above units are functions or means which are realized by any of the elements illustrated in FIG. 3 which operate according to instructions from CPU 201 which operates according to a browser software 6010 stored in the auxiliary storage apparatus 204 or the RAM 203.

Further, the server 40 has a storage unit 6000 including one or more of the auxiliary storage apparatuses 204, the RAM 203, and the ROM 202 illustrated in FIG. 3. The storage unit 6000 stores the browser software 6010. It should be noted that the browser software 6010 may be distributed in a state where the browser software 6010 is stored in a recording medium 220, or may be downloaded from the program providing server.

(Functions of Administrator PC 60)

The communication unit 61 is realized by the CPU 201, the network I/F 207, etc., illustrated in FIG. 3, and receives the HTML data from the server 40, and transmits to the server 40 the calculation condition input by the administrator from the calculation condition setting screen in FIG. 9.

The GUI display unit 62 is realized by the CPU 201, the display control unit 206, etc., illustrated in FIG. 3, and displays the calculation condition setting screen or the like on the display 210 by interpreting the HTML data.

The operation input accepting unit 63 is realized by the CPU 201, the input unit 205, etc., illustrated in FIG. 3, and accepts operations for the GUI, etc., from the user.

The storing and reading unit 69 is realized by the ROM 202, the RAM 203, the auxiliary storage apparatus 204, etc., illustrated in FIG. 3, and performs a process of storing various types of data sets in the storage unit 6000, and reading the data sets stored in the storage unit 6000.

<Setting of Standby Time>

In an embodiment, there are a case where the administrator operates the administrator PC 60 and sets the standby time in the image forming apparatus 20 of a customer whom the administrator belongs to, and a case where the administrator operates the image forming apparatus 20, and sets the standby time in the image forming apparatus 20 which the administrator is operating.

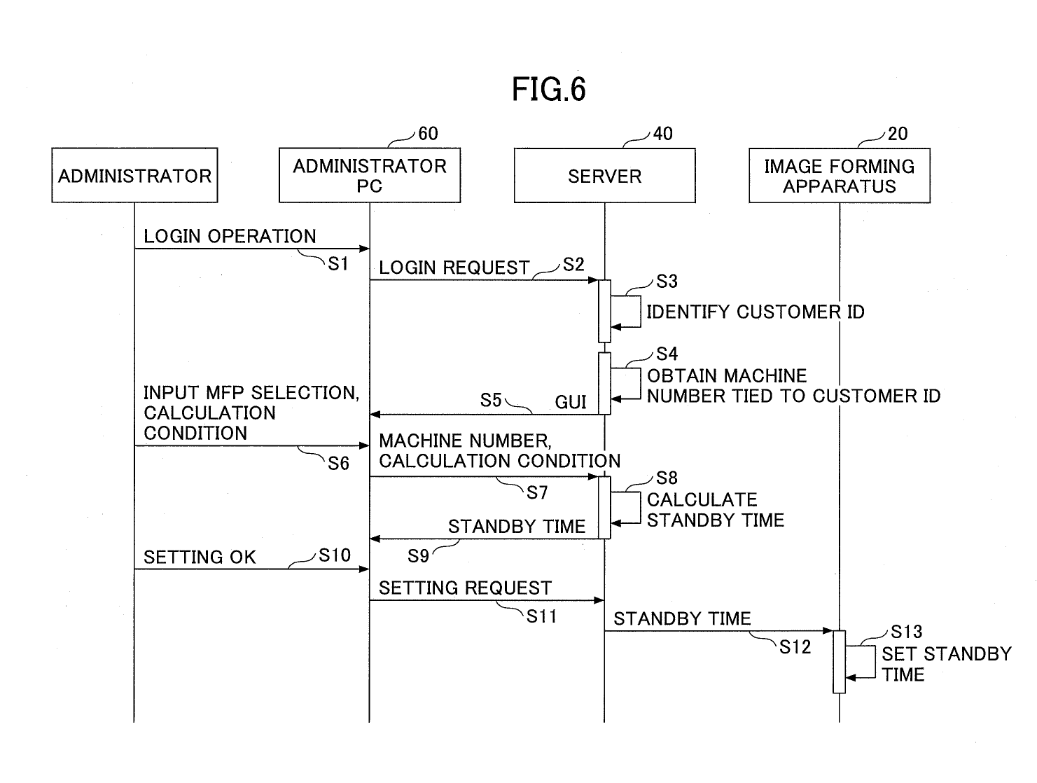

FIG. 6 is an example of a sequence diagram illustrating a procedure of setting a standby time in the image forming apparatus 20 of a customer by operating an administrator PC by the administrator.

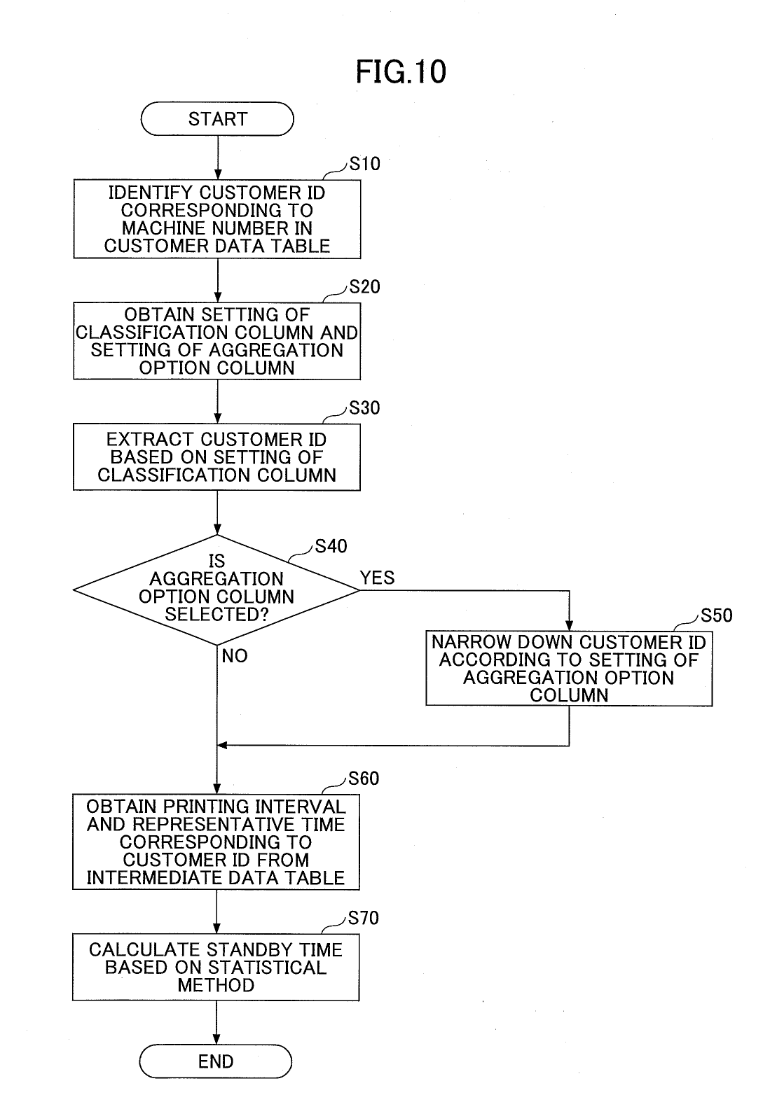

S1: The administrator operates the administrator PC 60 and performs a login operation. With the login operation, the administrator ID and password, or the PIN number, etc., are input.
S2: The operation input accepting unit 63 of the administrator PC 60 accepts the login operation, and the communication unit 61 transmits a login request to the server 40.
S3: The communication unit 41 of the server 40 receives the login request, and the authentication processing unit 43 of the server 40 authenticates the administrator. With the successful authentication, a customer ID of a customer whom the administrator belongs to can be identified.
S4: The server unit 44 of the server 40 reads from the customer data DB 4002 a machine number that is tied to the customer ID.
S5: The communication 41 of the server unit 44 generates HTML data according to which the calculation condition setting screen including the machine number, etc., is displayed, and transmits the generated data to the administrator PC 60.
S6: The GUI display unit 62 of the administrator PC 60 interprets the HTML data and displays the calculation condition setting screen, and thus, the administrator selects the image forming apparatus 20 based on the machine number, or inputs a calculation condition. It should be noted that the calculation condition includes a calculation method which will be described later.
S7: The operation input accepting unit 63 of the administrator PC 60 accepts the machine number and the calculation condition, and the communication unit 61 transmits the machine number and the calculation condition to the server 40.
S8: The calculation condition accepting unit 45 of the server 40 accepts the machine number and the calculation condition, and the time calculation unit 46 calculates the standby time. The detailed description will be provided by referring to FIG. 10.
S9: The communication unit 41 of the server 40 transmits the standby time to the administrator PC 60 for confirmation.
S10: The administrator PC 60 displays the standby time on the GUI, and thus, the administrator determines whether the standby time is appropriate, and inputs a setting OK.
S11: The operation input accepting unit 63 of the administrator PC 60 accepts the setting OK, and the communication unit 61 of the administrator PC 60 transmits a setting request to the server 40.
S12: The server 40 transmits the standby time to the image forming apparatus 20 selected in step S6. IP address of the image forming apparatus 20 may be registered in the server 40 beforehand, or, the standby time may be transmitted as a response to the transmission of the log data, etc., by the image forming apparatus 20.
S13: The communication unit 21 of the image forming apparatus 20 receives the standby time, and the standby time setting unit 25 stores the standby time in the storage unit 2000.

Therefore, in the case where the administrator accesses the server 40 via the administrator PC 60, the administrator can set the standby time in any of the image forming apparatuses 20 of the customer. It is possible to set the standby time in a plurality of the image forming apparatuses 20 together at once by selecting the multiple image forming apparatuses 20.

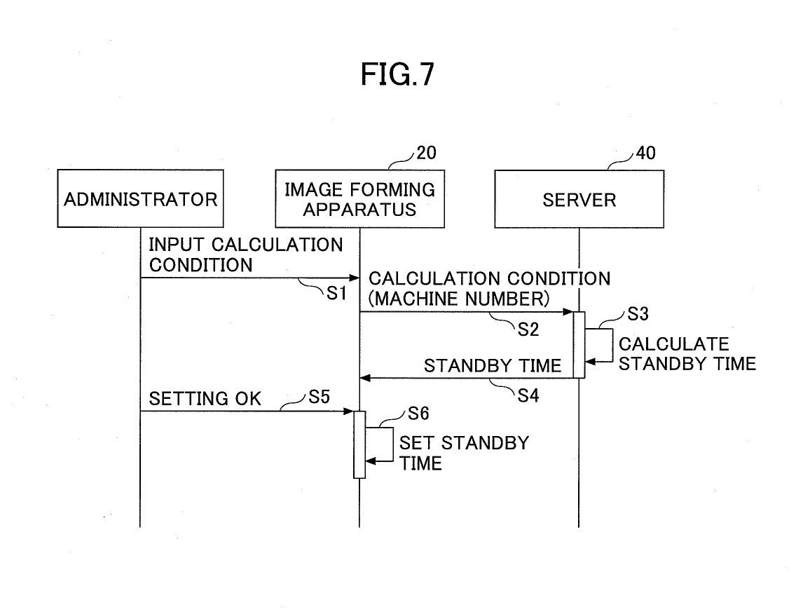

FIG. 7 is an example of a sequence diagram illustrating a procedure of setting the standby time in the image forming apparatus 20 operated by the administrator.

S1: The administrator operates the image forming apparatus 20 and inputs the calculation condition. The image forming apparatus 20 in which the standby time is going to be set is the image forming apparatus 20 the administrator is operating. Therefore, it is not necessary to login to the server 40 to identify the customer ID. However, in order to verify permission for setting the standby time, the administrator may be requested to perform a procedure to login to the image forming apparatus 20 or the server 40.
S2: The operation input accepting unit 22 of the image forming apparatus 20 accepts an input of calculation condition, and the communication unit 21 transmits the calculation condition and the machine number to the server 40. The machine number is stored in the storage unit 2000 of the image forming apparatus 20.
S3: The communication unit 41 of the server 40 receives the calculation condition and the machine number, and the time calculation unit 46 of the server 40 calculates the standby time. The detailed description will be provided by referring to FIG. 10. It should be noted that the server 40 can identify the customer ID from the customer data table because the machine number has been transmitted to the server 40.
S4: The communication unit 41 of the server 40 transmits the standby time to the image forming apparatus 20.
S5: The operation input accepting unit 22 of the image forming apparatus 20 displays the standby time on the operation unit 307, and thus, the administrator determines whether the standby time is appropriate, and inputs a setting OK.
S6: The operation input accepting unit 22 of the image forming apparatus 20 accepts the setting OK, and the standby time setting unit 25 sets the standby time in the image forming apparatus 20.

Therefore, in the case where the administrator accesses the server 40 via the image forming apparatus 20, it is not necessary for the administrator to select the image forming apparatus 20, and yet the administrator can set the standby time in the image forming apparatuses 20 which the administrator is operating.

It should be noted that it is possible for the administrator to login to the server 40 via the image forming apparatus 20, and that it is possible for the image forming apparatus 20 to interpret the HTML data, and thus it is also possible for the administrator to operate the image forming apparatus 20 to set the standby time in any one of the image forming apparatuses 20 of the customer. Therefore, FIGS. 6 and 7 are used for the sake of description convenience, and whether the administrator uses the administrator PC 60 or the image forming apparatus 20 does not create big limitations.

<Intermediate Data Table Generation>

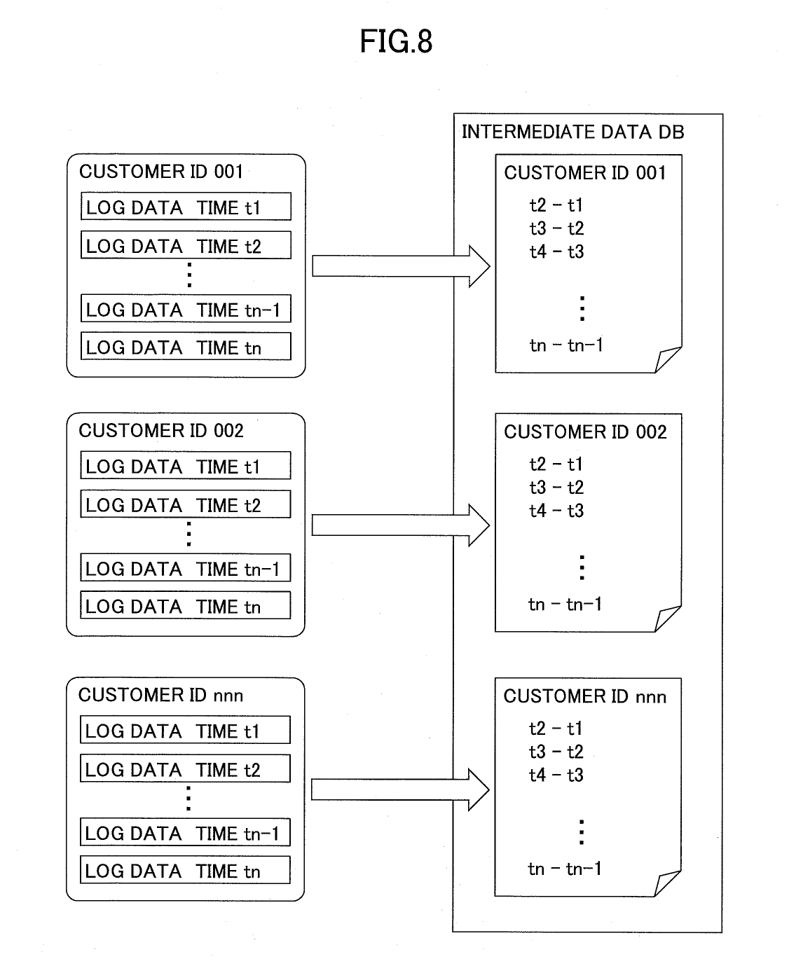

FIG. 8 is used for describing an intermediate data table generation method. In the intermediate data table, differences of the printing-date-and-time data items in the log data of the chronological order for the same customer ID are registered. The chronological order refers to a state in which the log data is sorted by the printing-date-and-time. If it is assumed that the log data is transmitted from the image forming apparatus 20 to the server 40 in the order of the printing-date-and-time, then the differences can be calculated by the time calculation unit 46 of the server 40 if only the log data is transmitted to the server 40. If it is assumed that time t1<time t2< . . . <time tn−1<time tn, then the time calculation unit 46 calculates “t2−t1”, “t3−t2”, “t4−t3”, . . . , “tn−tn−1”, and registers the calculation result associated with the customer ID in the intermediate data table. It should be noted that the value less than minute of the calculation result may be rounded up or truncated.

Further, the time calculation unit 46 extracts the hour part of the time t2 through tn (hour part of “hour:minute”) in order to record the representative time, and associates the representative time with the printing interval. With the above operation, the server 40 can calculate the standby time for each time zone. It should be noted that the time zone may not be recorded in the case where the standby time is not calculated for each time zone.

The above-described calculation is performed for each customer ID, and thus, the use time intervals of the image forming apparatus 20 at the customer can be recorded.

It should be noted that the intermediate data table may not need to be generated because the intermediate data table is used just for reducing the standby time calculation time.

<Calculation Condition Setting Screen>

FIG. 9 is a drawing illustrating an example of a calculation condition setting screen 500 displayed on the display 210 of the administrator PC 60. The calculation condition setting screen 500 is displayed in step S5 of FIG. 6 or in step S1 of FIG. 7. It is not necessary for the same calculation condition setting screen 500 to be displayed on the display 210 of the administrator PC 60 and the operation unit 307 of the image forming apparatus 20, but the similar information may be displayed and the similar information input may be accepted.

The calculation condition setting screen 500 includes an image forming apparatus selection column 501, a classification column 502, an aggregation option column 503, and a button column 504. In the following, the above columns will be described in order.

In the image forming apparatus selection column 501, at least one of the machine number and the name tied to the customer ID read from the customer data DB 4002 by the server 40 is displayed. In FIG. 3, the name is displayed. The user selects the image forming apparatus 20 for which the user wants to set the standby time by using a mouse or a finger. The GUI display unit 62 of the administrator PC 60 highlights the name of the image forming apparatus 20 selected by the administrator by using, for example, a reversed display.

The classification column 502 is used for inputting a filtering condition of the log data which is referenced when the server 40 calculates the standby time. In the classification column 502, a check box 502a corresponding to characters “customer size”, a check box 502b corresponding to characters “type of business”, and a check box 502c corresponding to characters “the number of employees per MFP” are displayed. In the case where the check box 502a is checked, the log data of customers whose “customer size” is the same as the customer the administrator belongs to is used for standby time calculation. In the case where the check box 502b is checked, the log data of customers whose “type of business” is the same as the customer the administrator belongs to is used for standby time calculation. In the case where the check box 502c is checked, the log data of customers whose “the number of employees per MFP” is the same as the customer the administrator belongs to is used for standby time calculation. The above data items are registered in the customer data table.

It is also possible for the administrator to check multiple check boxes 502a through 502c. In this case, the filtering condition is treated as a logical conjunction (AND). For example, in the case where all of the check boxes 502a through 502c are checked, the log data which satisfies all of the conditions that the log data of customers whose “customer size” is the same as the customer the administrator belongs to, that the log data of customers whose “type of business” is the same as the customer the administrator belongs to, and that the log data of customers whose “the number of employees per MFP” is the same as the customer the administrator belongs to, is used.

As described above, it is possible for the administrator to set preferable filtering conditions when calculating the standby time of the image forming apparatus 20 of a company the administrator belongs to. For example, it is considered to be effective to use the log data of the comparable customer size for calculating the standby time because there is a case where the employee's use frequency of the image forming apparatus 20 is comparable to the use frequency of the same customer size. Further, there is a case where the use frequency of the image forming apparatus 20 is comparable to the use frequency of the same type of business because employees of the same type of business may take a similar form of business. Further, it can be expected that, for example, the employee's use frequency of the image forming apparatus 20 is comparable to the use frequency of the same number of employees per MFP. Therefore, it is possible for the administrator to calculate an appropriate standby time by combining these filtering conditions.

The aggregation option column 503 is used for inputting an optional filtering condition which is a kind of filtering conditions of the log data which is referenced when the server 40 calculates the standby time. It is up to the administrator whether the aggregation option column 503 is checked because the aggregation option column 503 is optional. In the aggregation option column 503, a check box 503a corresponding to characters “use only use situation of own company”, a check box 503b corresponding to characters “aggregate by limiting to MFP”, and a check box 503c corresponding to characters “aggregate by limiting to LP” are displayed.

In the case where the check box 503a is checked, only the log data of the customer the administrator belongs to is used for standby time calculation. “MFP” of the check box 503b means a multifunction peripheral (an image forming apparatus having functions other than printer functions). In the case where the check box 503b is checked, only the log data of multifunction peripherals is used for standby time calculation. “LP” of the check box 503b means a printer (an image forming apparatus having only printer functions). In the case where the check box 503c is checked, only the log data of image forming apparatuses 20 having only printer functions is used for standby time calculation. It should be noted that whether an image forming apparatus 20 is MFP or LP can be determined according to a model number, etc., included in the machine number.

As described above, it is possible for the administrator to set preferable optional filtering conditions when calculating the standby time of the image forming apparatus 20 of a company the administrator belongs to. For example, the standby time calculated by using only the log data of the company reflects the printing intervals of the image forming apparatuses 20 when the image forming apparatuses 20 have been actually used in the company the administrator belongs to. Therefore, the option is useful in the case where the image forming apparatus 20 has already been used for a certain period. Further, in the case where a new image forming apparatus 20 is installed in the company, a standby time can be set which is calculated from the log data of the image forming apparatuses 20 which have already been installed.

Further, it is known, for example, that there is a user use difference between an MFP and an LP. For example, there is a tendency that a user selects an MFP of many functions, and that the use frequency of MFP is higher than the use frequency of LP. Therefore, in the case where an image forming apparatus 20 in which a standby time is going to be set is an MFP, it may be effective for the administrator to select the check box 503b. Further, in the case where an image forming apparatus 20 in which a standby time is going to be set is an LP, it may be effective for the administrator to select the check box 503c.

It is also possible for the administrator to check multiple check boxes 503a through 503c. In this case, the filtering condition is treated as a logical conjunction (AND). For example, in the case where the check boxes 503a and 503b are checked, the log data of only MFPs of the image forming apparatuses 20 of the customer the administrator belongs to is used for standby time calculation.

The button column 504 is used for specifying a calculation method when calculating the standby time. The button column 504 includes an average obtaining button 504a, a median obtaining button 504b, a mode obtaining button 504c, and a cancel button 504d. The calculation method includes, for example, calculating the average, the median, or the mode. The average obtaining button 504a is used for specifying that the standby time is calculated as the average of the printing intervals of the log data. The median obtaining button 504b is used for specifying that the standby time is calculated as the median of the printing intervals of the log data. The mode obtaining button 504c is used for specifying that the standby time is calculated as the mode of the printing intervals of the log data.

<Standby Information Calculation Process>

FIG. 10 is an example of a flowchart illustrating a procedure of calculating a standby time by the server 40. The process of FIG. 10 is executed in step S8 of FIG. 6 or in step S3 of FIG. 7. It should be noted that it is assumed that the intermediate data table has already been generated.

When the communication unit 41 of the server 40 receives the machine number and the calculation condition, the calculation condition accepting unit 45 identifies a customer ID associated with the machine number in the customer data table (S10). With the above operation, the customer size, the type of business, and the number of employees per MFP of the customer can be identified. It should be noted that the customer ID itself may be obtained from the administrator PC 60 or the image forming apparatus 20. Alternatively, the customer ID identified in step S3 of FIG. 6 may be used.

Further, the calculation condition accepting unit 45 analyzes the calculation condition transmitted from the image forming apparatus 20, and obtains the setting of the classification column 502 and the setting of the aggregation option column 503 of the calculation condition setting screen 500 (S20).

Next, the time calculation unit 46 extracts customer IDs based on the setting of the classification column 502 (S30). Specifically, in the case where the administrator has selected “customer size”, the time calculation unit 46 reads customer IDs whose customer size is the same as identified in step S10. In the case where the administrator has selected “type of business”, the time calculation unit 46 reads customer IDs whose type of business is the same as identified in step S10. In the case where the administrator has selected “the number of employees per MFP”, the time calculation unit 46 reads customer IDs whose number of employees per MFP is the same as identified in step S10.

For example, in the case where the administrator has selected “customer size” and the customer size of the customer which the administrator belongs to is medium, the time calculation unit 46 obtains customer IDs whose customer size is medium from the customer data table. In the case where the administrator has selected “the number of employees per MFP” and the number of employees per MFP of the customer which the administrator belongs to is G1, the time calculation unit 46 obtains customer IDs whose number of employees per MFP is G1 from the customer data table.

Next, the time calculation unit 46 determines whether the aggregation option column 503 is selected (S40).

In the case where the determination in step S40 is YES, the time calculation unit 46 further narrows down the customer IDs extracted in step S30 according to the setting of the aggregation option column 503 (S50). For example, in the case where “use only use situation of own company” has been selected, the time calculation unit 46 extracts customer IDs of the company the administrator belongs to from the customer IDs extracted in step S30. In the case where “aggregate by limiting to MFP” or “aggregate by limiting to LP” has been selected, the time calculation unit 46 narrows down the customer IDs extracted in step S30 by obtaining customer IDs having only MFP or LP from the customer data table.

Next, the time calculation unit 46 obtains printing intervals and representative times corresponding to the customer IDs extracted from the intermediate data table in step S30 or S40 (S60).

Next, the time calculation unit 46 calculates the standby time from the printing intervals obtained in step S60 based on the calculation method (S70). Specifically, the time calculation unit 46 calculates the standby time by classifying the representative times into predetermined time zones including 8 o'clock to 12 o'clock, 12 o'clock to 13 o'clock, 13 o'clock to 17 o'clock, 17 o'clock to 21 o'clock, 21 o'clock to 8 o'clock, etc., and by statistically processing the printing intervals of each time zone.

<<Standby Time Calculation of Each Calculation Method>>

In the case where the average obtaining button 504a is selected in the button column 504, the time calculation unit 46 calculates the average of the printing intervals. The calculated average is the standby time. The calculation will be described by referring to the intermediate data table illustrated in Table 7 as an example. It should be noted that in fact, as described above, only the printing intervals extracted from the intermediate data table based on one or more of the customer size, type of business, the number of employees per MFP, and the setting of the aggregation option column 503, is used for the standby time calculation.

Standby time of a customer of customer ID=001 in Table 7 is “(2+3+4)/3=3 (minutes)”. In the case where the median obtaining button 504b is selected in the button column 504, the time calculation unit 46 calculates the median of the printing intervals. The time calculation unit 46 sorts the printing intervals for each time zone. Further, assuming that the number of data items (the number of printing intervals) in each time zone is n, the median is calculated as follows.
In the case where (n+1) is an even number, the median=the (n+1)/2 th printing interval.
In the case where (n+1) is an odd number, the median=an average of the k-th printing interval and the (k+1)th printing interval, assuming that the quotient of (n+1)/2 is k. Taking the intermediate data table of Table 7 as an example, for a customer of customer ID=001, the number of data items n is 3, and n+1=3+1=4, which is an even number. Therefore, the standby time is (3+1)/2=2nd printing interval, which is 3 minutes.

For a customer of customer ID=002, the number of data items is 4, and n+1=4+1=5, which is an odd number. (4+1)/2=2, remainder 1, and thus, the quotient k is 2. Therefore, the standby time is 8.5 minutes as an average of the 2nd printing interval 7 minutes and the 3rd printing interval 10 minutes.

In the case where the mode obtaining button 504c is selected in the button column 504, the time calculation unit 46 calculates the mode of the printing intervals. The printing intervals are described in the unit of a minute. Therefore, the time calculation unit 46 counts how many data items are there whose printing interval is 1 minute, how many data sets are there whose printing interval is 2 minutes, how many data sets are there whose printing interval is 3 minutes, etc., and how many data sets are there whose printing interval is maximum minutes. The “maximum minutes” is the maximum printing interval in the extracted printing intervals. The standby time is the printing interval whose counted value is the largest.

Taking the intermediate data table of Table 7 as an example, for a customer of customer ID=003, the largest count is counted for the printing interval 5 minutes, and thus, the standby time is 5 minutes.

<Resizing of Intermediate Data Table>

Every time the image forming apparatus 20 of the machine system 100 transmits the log data, one record is registered in the intermediate data table, and thus, the size of the intermediate data table grows as time elapses. Therefore, it is preferable to periodically resize the intermediate data table. By periodically resizing the intermediate data table, it is possible to prevent the time required for calculating the standby time from increasing.

The resizing unit 47 of the server 40 deletes an intermediate data item of the intermediate data table according to a delete target condition. As the delete target condition, for example, a condition in which a printing interval of the past which is equal to or older than a predetermined past (e.g., equal to or older than 2 years, one year, or 90 days, etc.,) can be listed. In this case, the intermediate data table may include the printing-date-and-time as is instead of the representative time. The resizing unit 47 deletes intermediate data items whose printing-date-and-time is equal to or older than the predetermined past in the intermediate data table.

It should be noted that there is a case where it is preferable that information may not be deleted even if the information is old. For example, in the case where the number of the log data items of a customer is small, there is a possibility that a situation may occur in which the number of the log data items is insufficient for statistically calculating the standby time when “use only use situation of own company” is selected in the aggregation option column 503. Therefore, the resizing unit 47 deletes old intermediate data items while leaving a predetermined number of data items (so that the number of data items does not become equal to or less than the predetermined number).

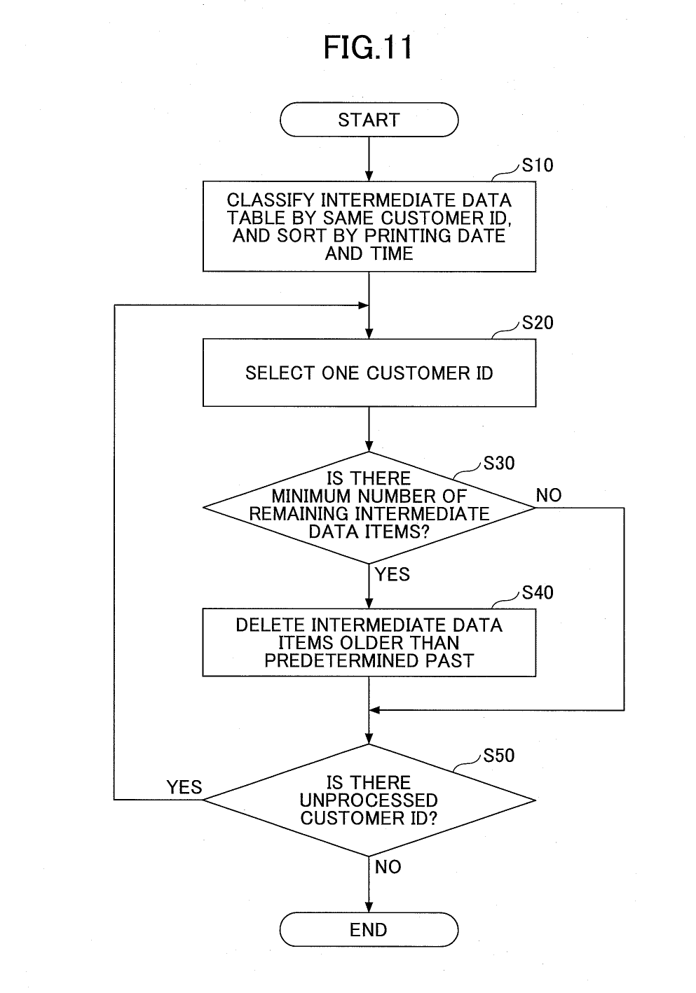

FIG. 11 is an example of a flowchart illustrating a procedure of resizing the intermediate data table by a resizing unit 47. The procedure illustrated in FIG. 11 is executed a maximum of once a day when processing load of the server 40 is decreased.

The resizing unit 47 classifies the intermediate data table by the same customer ID, and sorts the classified intermediate data table by the printing-date-and-time for each customer ID (S10).

Next, the resizing unit 47 selects a customer ID (S20). The resizing unit 47 may select a customer ID in ascending order, in descending order, or at random.

Next, the resizing unit 47 determines whether the number of the intermediate data items of the selected customer ID is greater than the minimum remaining number (S30). In the case where the determination in step S30 is NO, the intermediate data item should not be deleted, and the process moves to step S50.

In the case where the determination in step S30 is YES, the resizing unit 47 deletes intermediate data items equal to or older than a predetermined past (S40).

The resizing unit 47 repeats the processes in steps S20 through S40 while there is unprocessed customer ID (S50).

<Standby Time Calculation Utilizing Calendar>

It should be noted that, in a typical company, the printing interval greatly differs according to whether it is a weekday or a holiday. Further, even if it is a weekday, there may be a case where business contents differ from other weekdays when it is a beginning of month or the end of month. However, in the above calculation example, standby time calculation is classified only by the time zones of a day, and whether it is a weekday or a holiday is not distinguished.

Therefore, in the following, the standby time calculated according to the day of the week, etc., by utilizing a calendar will be described. Specifically, the following rule is used in the calculation.

(a) A standby time of a weekday is calculated by using the log data of a weekday closest to today or a day after of the last year or earlier.
(b) A standby time of a first weekday of the 1st day of month or later is calculated by using the log data of a first weekday of the 1st day of month or later of the same month of the last year or earlier.
(c) A standby time of a last weekday of the 31st day of month or earlier is calculated by using the log data of a last weekday of the 31st day of month or earlier of the same month of the last year or earlier.
(d) A standby time of a Saturday or a Sunday is calculated by using the log data of a Saturday or a Sunday closest to today of the last year or earlier.
(e) A standby time of a public holiday is calculated by using the log data of the same public holiday of the last year or earlier.

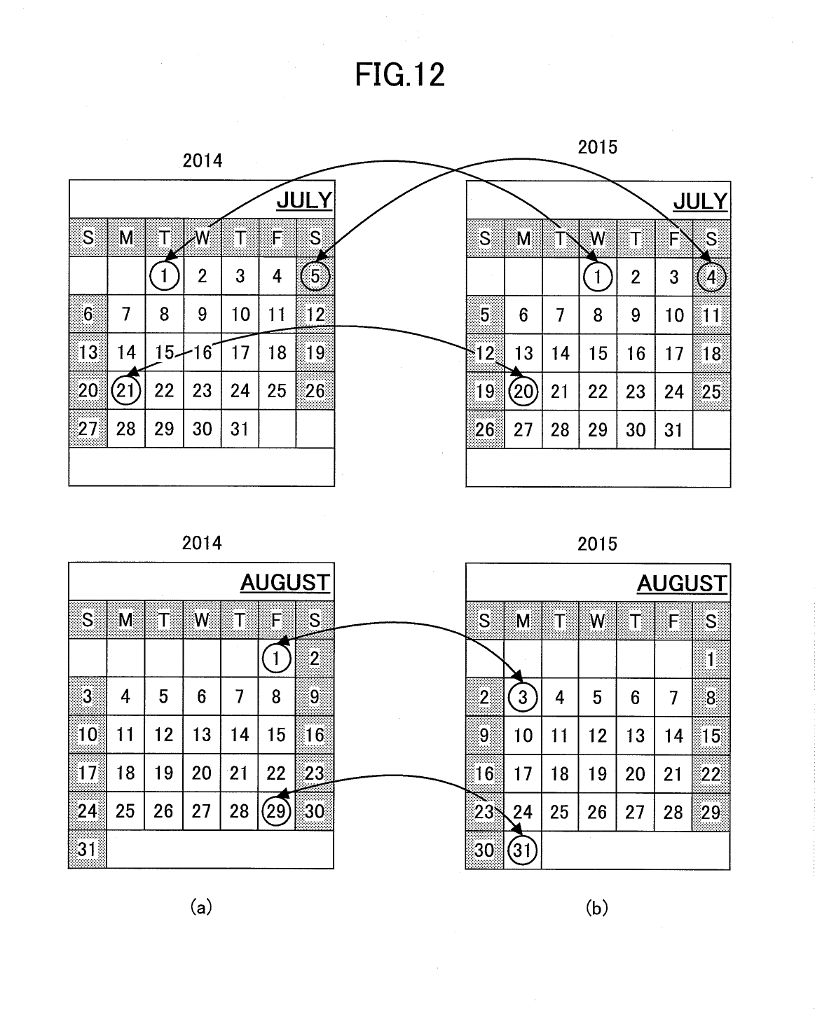

The standby time calculation will be described by referring to FIG. 12. FIG. 12 is an example of a drawing illustrating a standby time calculation by using a calendar. A calendar of July and August of 2014 is illustrated in (a) of FIG. 12. A calendar of July and August of 2015 is illustrated in (b) of FIG. 12.

For example, Jul. 1, 2015 is a first weekday of the first day of the month or later. Therefore, the standby time of Jul. 1, 2015 is calculated by using the log data of a weekday, Jul. 1, 2014.

Further, Jul. 4, 2015 is Saturday and Jul. 4, 2014 is a weekday. Therefore, the standby time of Jul. 4, 2015 is calculated by using the log data of Jul. 5, 2014, which is the first Saturday of Jul. 4, 2014 or later.

Further, Jul. 20, 2015 is a public holiday. Therefore, the standby time of Jul. 20, 2015 is calculated by using the log data of Jul. 21, 2014, which is the same public holiday.

Further, Aug. 3, 2015 is a first weekday of the first day of the month or later. Therefore, the standby time of Aug. 3, 2015 is calculated by using the log data of Aug. 1, 2014, which is the first weekday of the same month.

Aug. 31, 2015 is a last weekday of the 31st day of the month or earlier. Therefore, the standby time of Aug. 31, 2015 is calculated by using the log data of Aug. 29, 2014, which is the last weekday of the 31st day of the same month or earlier.

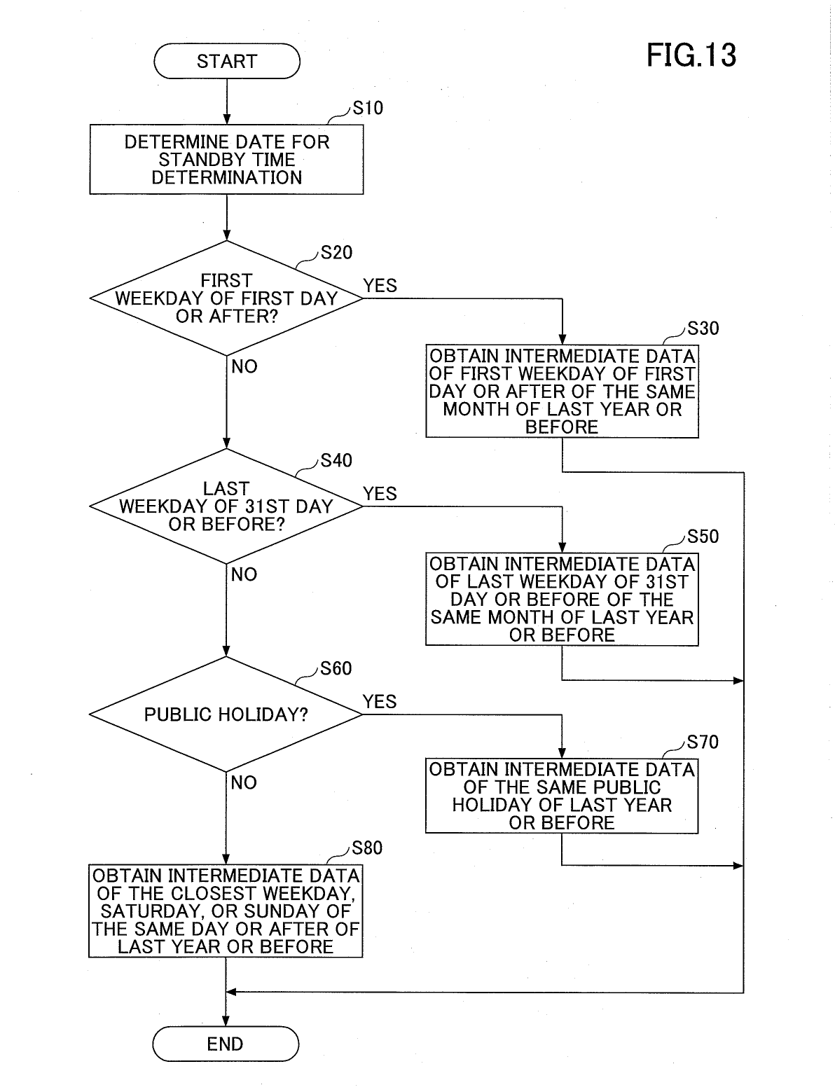

FIG. 13 is an example of a flowchart illustrating a procedure of obtaining log data by the time calculation unit 46 by using a calendar. The process of FIG. 13 may be executed on the day before the day on which the standby time is determined or earlier. Further, it is assumed that the extraction of customer ID has already been performed based on the company size, the type of business, the number of employees per MFP, and the setting of the aggregation option column 503.

First, the time calculation unit 46 determines the date for which the time calculation unit 46 calculates the standby time (S10). For example, the time calculation unit 46 determines the next day of the day the process of FIG. 13 is performed as the date for which the time calculation unit 45 calculates the standby time.

Next, the time calculation unit 46 determines whether the date determined in step S10 is a first weekday of the first day of the month or later (S20).

In the case where the determination in step S20 is YES, the time calculation unit 46 obtains intermediate data of a first weekday of the 1st day of the month or later of last year or earlier (S30). In other words, the time calculation unit 46 identifies the date of a first weekday of the 1st day of the month or later by referring to the calendar of the same month of last year or earlier. Further, the time calculation unit 46 obtains the intermediate data items whose printing-date-and-time belongs to the identified date.

In the case where the determination in step S20 is NO, the time calculation unit 46 determines whether the date determined in step S10 is a last weekday of the 31st day or before (S40).

In the case where the determination in step S40 is YES, the time calculation unit 46 obtains intermediate data of a last weekday of the 31st day of the month or earlier of last year or earlier (S50). In other words, the time calculation unit 46 identifies the date of a last weekday of the 31st day of the month or earlier by referring to the calendar of the same month of last year or earlier. Further, the time calculation unit 46 obtains the intermediate data items whose printing-date-and-time belongs to the identified date.

In the case where the determination in step S40 is NO, the time calculation unit 46 determines whether the date determined in step S10 is a public holiday (S60).

In the case where the determination in step S60 is YES, the time calculation unit 46 obtains intermediate data of the same public holiday of last year or earlier (S70). In other words, the time calculation unit 46 identifies the date of the same public holiday by referring to the calendar of the same month of last year or earlier. Further, the time calculation unit 46 obtains the intermediate data items whose printing-date-and-time belongs to the identified date.

In the case where the determination in step S60 is NO, the time calculation unit 46 obtains intermediate data of a weekday, a Saturday, or a Sunday closest to the same day or later of last year or earlier (S80). In other words, the time calculation unit 46 identifies a weekday, a Saturday, or a Sunday closest to the date determined in step S10 or later, by referring to the calendar of the same month of last year or earlier. Further, the time calculation unit 46 obtains the intermediate data items whose printing-date-and-time belongs to the identified date. It should be noted that in the case where the date does not exist in the same day or later of last year or earlier, the intermediate data of the last weekday, Saturday, or Sunday of the same month of last year or earlier may be obtained.

By using a calendar as described above, the standby time of a date can be calculated, which standby time reflects whether the date is a beginning of month, the end of month, a public holiday, a weekday, or a holiday. Therefore, it becomes easy to calculate the standby time which reflects the company's form of business.

<Determination of Optimal Calculation Method>

In the calculation condition setting screen 500 of FIG. 9, the administrator selects a calculation method. However, the server 40 may propose an optimal calculation method. In the case where the image forming apparatus 20 of the customer the administrator belongs to has already transmitted sufficient log data to the server 40, it is possible for the server 40 to verify the standby time calculated from the log data of the company.

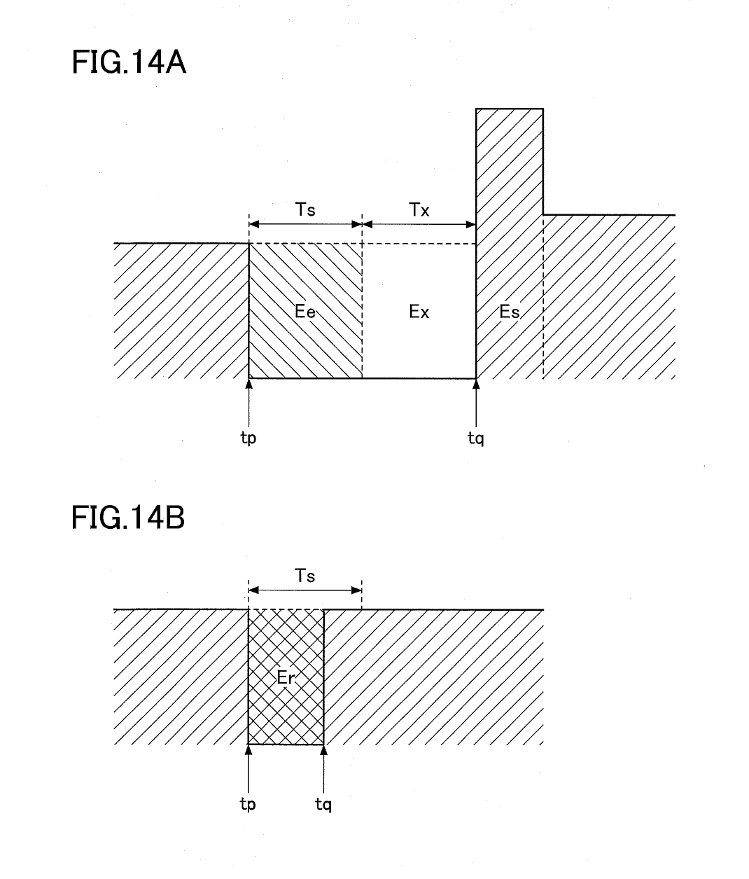

FIGS. 14A and 14B are examples of a drawing illustrating a verification of a calculation method based on a calculated standby time. In FIGS. 14A and 14B, printing-date-and-time data items tp, tq, and a standby time Ts are illustrated, and energy consumption is illustrated by a shaded area.

FIG. 14A illustrates a case where tq−tp>Ts. As a result, energy Ee is consumed in standby time Ts. Further, starting energy Es is consumed for returning to a normal mode. However, energy Ex is saved in waiting time Tx. According to the above, energy consumption in the case where tq−tp>Ts is calculated as follows.

Energy Consumption A=Ee+Es−Ex

It should be noted that Ee or Es may simply be a constant value, Ex is proportional to Tx, and Ex can be calculated by multiplying Tx by a proportionality constant.

FIG. 14B illustrates a case where tq−tp≦Ts. In this case, energy Er is consumed during (tq−tp), but starting energy Es is not consumed.

Energy Consumption B=Er

It should be noted that Er is proportional to (tq−tp), and thus, Er can be calculated by multiplying (tq−tp) by a proportionality constant.

Therefore, it is possible to estimate how much the calculated standby time contributes to the energy consumption by calculating the energy consumption in the case where tq−tp>Ts and in the case where tq−tp≦Ts. It is possible to determine the optimal calculation method by calculating the energy consumption by using each of the three calculation methods.

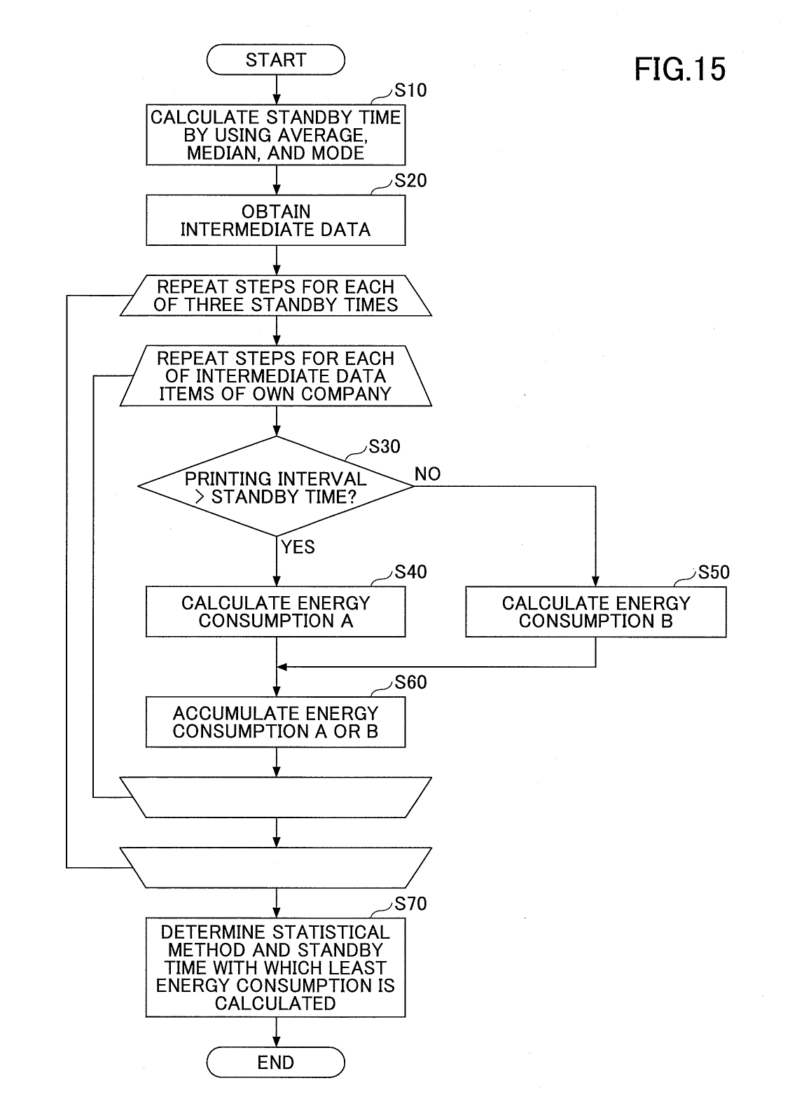

FIG. 15 is an example of a flowchart illustrating a procedure of selecting the standby time by the selection unit 48. The process of FIG. 15 is executed in step S8 of FIG. 6 or in step S3 of FIG. 7. In this case, it is assumed that the administrator has selected a button such as “select the optimal statistical process” in the button column 504.

The time calculation unit 46 calculates the standby time for the customer the administrator belongs to by using each of the three calculation methods (S10).

Next, the selection unit 48 obtains the intermediate data of the customer the administrator belongs to from the intermediate data table (S20).

Further, the following steps S30 through S60 are repeatedly executed for each of the three standby times and for each of the intermediate data items of the company.

First, the selection unit 48 determines whether the standby time is less than the printing interval (S30).

In the case where the determination in step S30 is YES, the selection unit 48 calculates the energy consumption A (S40).

In the case where the determination in step S30 is NO, the selection unit 48 calculates the energy consumption B (S50).

The selection unit 48 accumulates the energy consumption A and the energy consumption B for all intermediate data items (S60).

After the energy consumption for each of the three standby times is calculated, the selection unit 48 determines the calculation method of the three methods and corresponding standby time by which the least energy consumption has been calculated (S70).

The standby time determined as described above is transmitted to the administrator PC 60, the administrator inputs setting OK, and the standby time is set in the image forming apparatus 20 of the company. Therefore, it is possible to set the standby time in the image forming apparatus 20 of the company, which standby time provides the least energy consumption.

As described above, it is possible for the image forming apparatus 20C according to an embodiment to transition to an energy saving mode with the standby time optimized by the filtering conditions from the beginning of installation of the image forming apparatus 20C. Further, after the image forming apparatus 20 has been used for a certain period, it is possible to transition to an energy saving mode with the standby time optimal for the use form.

### Embodiment 2

In the embodiment 1, after the standby time is set by the server 40 in the image forming apparatus 20, the standby time is not optimized even if the optimal value of the standby time is changed by the continued use of the image forming apparatus 20 by the customer. Further, in principle, it is necessary for the administrator of the customer to select the value from the average, the median, and the mode to be set in the image forming apparatus 20, and it is not possible for the administrator to know which value is optimal.

Therefore, in an embodiment, the server 40 calculates and records the energy consumption of the day based on each of the average, the median, and the mode by using the printing-date-and-time data items of the image forming apparatus 20 of the customer and the energy consumption of the model the customer uses. Further, for example, once a month, the server 40 sets in the image forming apparatus 20 of the customer the value of the average, the median, or the mode, with which value the number of the days of the month, in which the energy consumption of the day is the least, is largest.

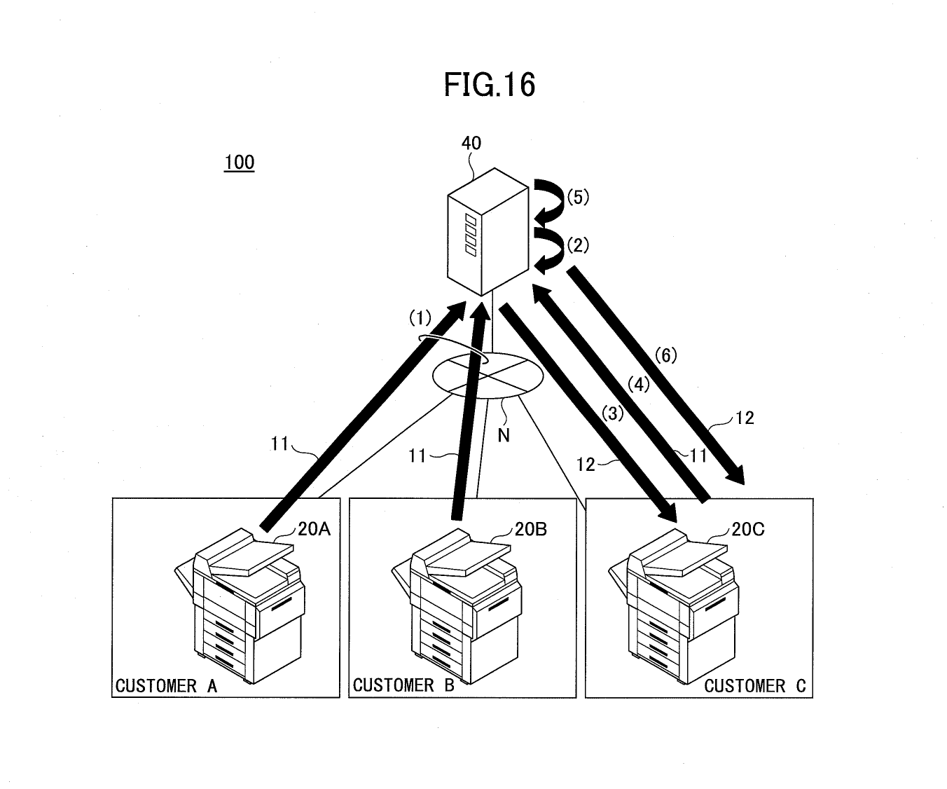

FIG. 16 is an example of a drawing illustrating an overall operation of the machine system 100 according to an embodiment. It should be noted that, in the specification, elements with the same reference numeral perform the same function, and thus, there may be a case where the redundant description of which is omitted, or only the difference of which is described.

(1) The image forming apparatuses 20A and 20B mainly periodically transmit log data 11 to the server 40. The log data 11 includes at least printing-date-and-time (use time) of the image forming apparatuses 20A and 20B.
(2) The server 40 statistically processes intervals of printing-date-and-time data items included in the log data 11, and calculates the average, the median, and the mode.
(3) The server 40 transmits any one of the average, the median, and the mode as the standby time 12 to the image forming apparatus 20C, and an appropriate standby time is set in the image forming apparatus 20C. The above is the setting of the standby time for the first time. It should be noted that, for the sake of description convenience, it is assumed that the average is transmitted to the image forming apparatus 20C in the setting for the first time in an embodiment.
(4) The image forming apparatus 20C mainly periodically transmit log data 11 to the server 40. The log data 11 includes at least printing-date-and-time of the image forming apparatus 20C.
(5) The server 40 calculates the energy consumption of the day in the case where each of the average, the median, and the mode calculated in (2) based on the printing-date-and-time of the image forming apparatus 20C is set in the image forming apparatus 20C. The details will be described later.
(6) The server 40 sets as the standby time 12 in the image forming apparatus 20C, for example, any one of the average, the median, and the mode, with which the number of the days of the month, in which the energy consumption of the day is the least, is largest.

Therefore, in the machine system 100 according to an embodiment, every day energy consumption based on the individual use record of the customer is calculated, and it is possible to set the standby time in the image forming apparatus 20, which standby time is calculated based on the calculation method with which the number of the days in the last month, in which days the energy consumption of the day calculated based on the average, the median, or the mode is the least, is the largest.

<Functions>

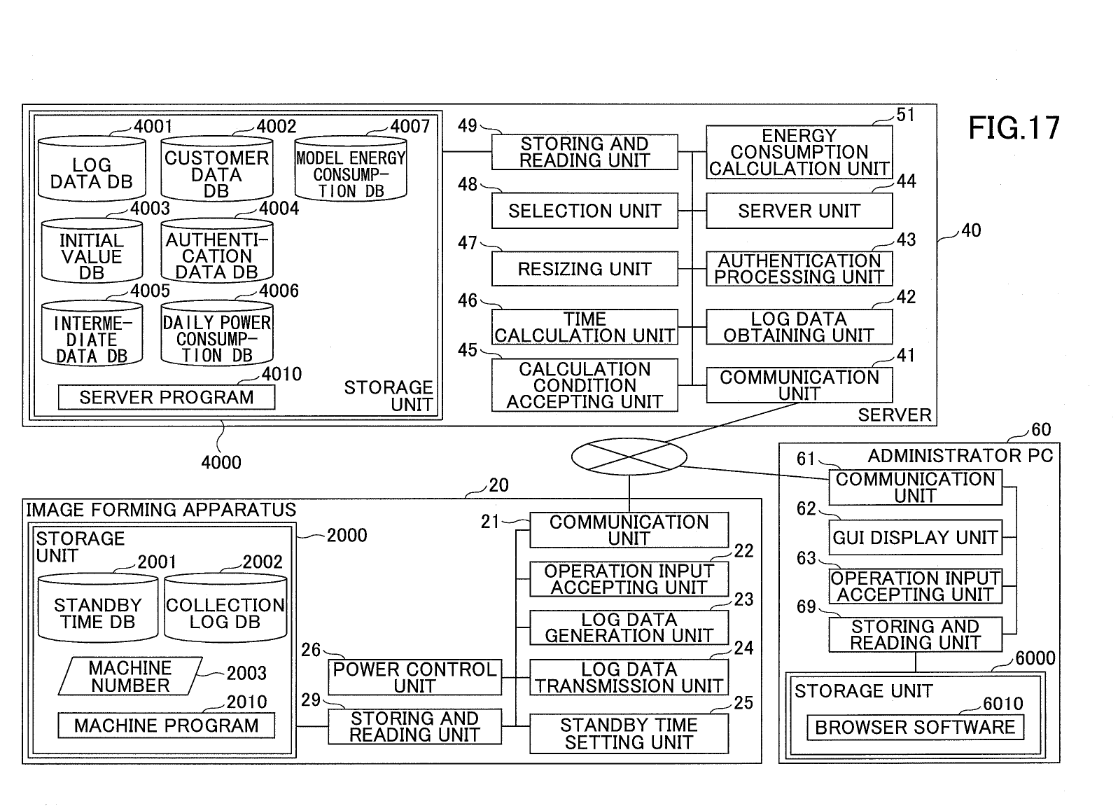

FIG. 17 is an example of a functional block diagram of the machine system 100 according to an embodiment. In FIG. 17, elements with the same reference numerals as in FIG. 5 have the same functions, and there will be a case in which only main elements are described.

The server 40 according to an embodiment further includes a energy consumption calculation unit 51. Further, the storage unit 4000 includes a daily energy consumption DB 4006 and a model energy consumption DB 4007.

TABLE 8
MODEL ENERGY CONSUMPTION TABLE

| MODEL | | ENERGY |
|---|---|---|
| NUMBER | KIND | CONSUMPTION |
| K001 | START UP TIME | 10 Wh |
| | IN-OPERATION TIME | 5 Wh |
| | WAITING TIME | 2 Wh |

The storage unit 4000 includes the model energy consumption DB 4007 in which a model energy consumption table illustrated in Table 8 is stored. The model energy consumption table includes items “model number”, “kind”, and “energy consumption”. The kind indicates operation modes with different energy consumptions. Of all the energy consumptions, the energy consumption of start up time indicates energy consumed at a start up time, the energy consumption of in-operation time or waiting time indicates energy consumed in unit time.

TABLE 9
DAILY ENERGY CONSUMPTION TABLE

| | | STANDBY TIME WITH |
|---|---|---|
| | | WHICH ENERGY |
| MACHINE | | CONSUMPTION OF THE |
| NUMBER | DATE | DAY IS MINIMUM |
| A | 20150101 | 10 |
| | 20150102 | 15 |
| | 20150103 | 7 |
| | . | . |
| | . | . |
| | . | . |

The storage unit 4000 includes the daily energy consumption DB 4006 in which a daily energy consumption table illustrated in Table 9 is stored. The daily energy consumption table includes items “machine number”, “date”, and “standby time with which energy consumption of the day is the smallest”. Based on the daily energy consumption table, for example, the standby time is known for each day of a month, with which standby time the energy consumption of the day is the least, and thus, it is possible to determine the standby time which should be set in the following month. The standby time is one of the average, the median, and the mode. A method of generating the daily energy consumption table will be described later.

<Server Functions>

The energy consumption calculation unit 51 included in the server 40 is realized by the CPU 301, etc., illustrated in FIG. 3, and calculates the energy consumption of a day in the case where each of the average, the median, and the mode is set in the image forming apparatus 20 based on the printing-date-and-time data items collected from the image forming apparatus 20.

<Initial Value Data Table>

As described in the embodiment 1, the server 40 generates the intermediate data table, and the initial value data table is obtained from the intermediate data table. In an embodiment, each of the average, the median, and the mode is calculated from the intermediate data table, and recorded in the initial value data table.

TABLE 10

| | INITIAL VALUE DATA TABLE | | | | |
|---|---|---|---|---|---|
| | MACHINE | | | | |
| | NUMBER | TIME ZONE | AVERAGE | MEDIAN | MODE |
| (a) | A | 8 O’CLOCK TO | 10 MINUTES | 7 MINUTES | 15 MINUTES |
| | | 12 O’CLOCK | | | |
| | | 12 O’CLOCK TO | | | |
| | | 13 O’CLOCK | 10 MINUTES | 7 MINUTES | 15 MINUTES |
| | | 13 O’CLOCK TO | | | |
| | | 17 O’CLOCK | 10 MINUTES | 7 MINUTES | 15 MINUTES |
| | | 17 O’CLOCK TO | | | |
| | | 21 O’CLOCK | 10 MINUTES | 7 MINUTES | 15 MINUTES |
| | | 21 O’CLOCK TO | 10 MINUTES | 7 MINUTES | 15 MINUTES |
| | | 8 O’CLOCK | | | |

| | INTERMEDIATE DATA TABLE | | | | | | |
|---|---|---|---|---|---|---|---|
| | | | | | START | START | START |
| | CUSTOMER | PRINTING- | PRINTING | | FLAG | FLAG | FLAG |
| | ID | DATE-AND-TIME | INTERVAL | | (AVERAGE) | (MEDIAN) | (MODE) |
| (b) | 001 | 20150101 | 11 | MINUTES | S | S | |
| | | 00:05:00 | | | | | |
| | 001 | 20150101 | 8 | MINUTES | | S | |
| | | 00:13:00 | | | | | |
| | 001 | 20150101 | 19 | MINUTES | S | S | S |
| | | 00:32:00 | | | | | |
| | 001 | 20150101 | 1 | MINUTE | | | |
| | | 00:33:00 | | | | | |
| | 001 | 20150101 | 5 | MINUTES | | | |
| | | 00:38:00 | | | | | |

Table 10 (a) illustrates an example of the initial value data table according to an embodiment. As described above, in the initial value data table, “average”, “median”, and “mode” of the printing intervals is registered for each set of “machine number” and “time zone”. It should be noted that, for the sake of description convenience, there may be a case where “time zone” is omitted in the following description.

Table 10 (b) illustrates an example of the intermediate data table according to an embodiment. In the intermediate data table, “printing interval”, “start flag (average)”, “start flag (median)”, and “start flag (mode)” are registered for each set of “customer ID” and “printing-date-and-time”. The printing-date-and-time may be a representative time as in the embodiment 1. The start flag (average), the start flag (median), and the start flag (mode) are used for indicating whether the image forming apparatus 20 starts up in the case where the printing interval in the intermediate data table occurs. For example, in the case where the printing interval is 11 minutes, if it is assumed that the standby time is the average (10 minutes), then the image forming apparatus 20 will starts up (“S” is set). If it is assumed that the standby time is the median (7 minutes), then the image forming apparatus 20 will also starts up (“S” is set). On the other hand, if it is assumed that the standby time is the mode (15 minutes), then the image forming apparatus 20 will not start up. The image forming apparatus 20 starts up in the case where “printing interval”>“standby time”. Therefore, whether the start flag should be set is determined by checking whether “printing interval−the average”, “printing interval−the median”, and “printing interval−the mode” are positive. The start flag is used for calculating daily energy consumption which will be described later.

<Calculation Condition Setting Screen>

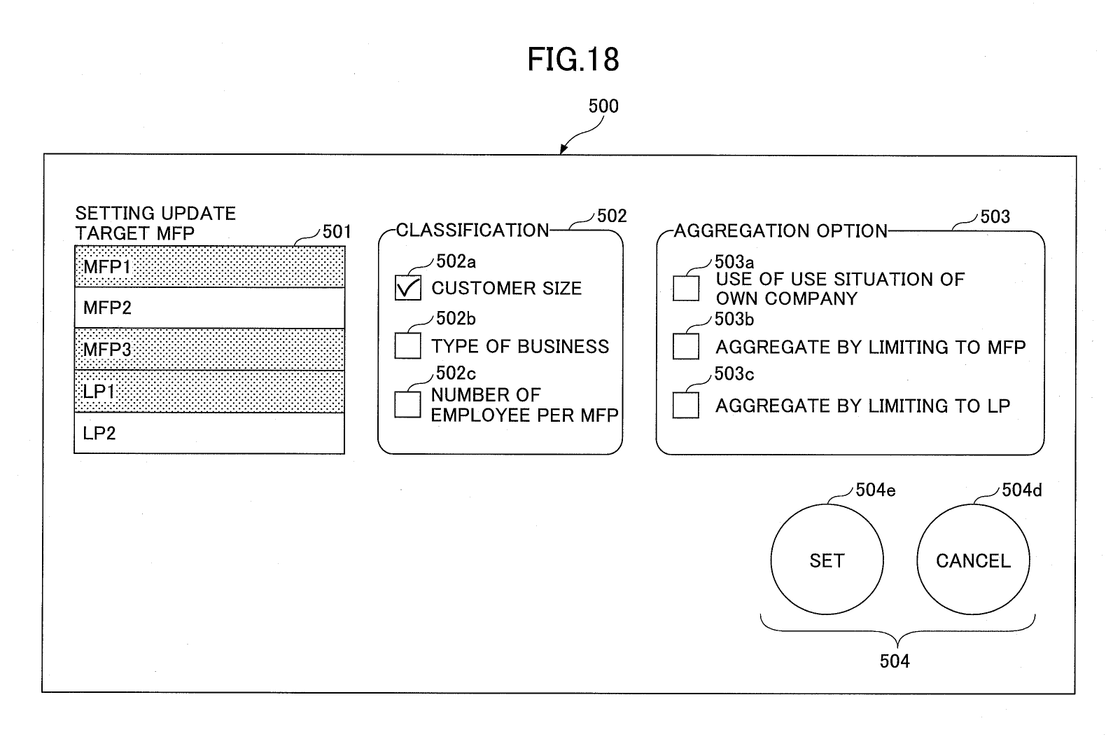

FIG. 18 is a drawing illustrating an example of a calculation condition setting screen 500 displayed on the display 210 of the administrator PC 60 according to an embodiment. It should be noted that, in FIG. 18, elements with the same reference numerals as in FIG. 9 have the same functions, and there will be a case in which only main elements according to an embodiment are described.

The calculation condition setting screen 500 in FIG. 18 includes a setting button 504e and a cancel button 504d in the button column 504. In other words, the average obtaining button 504a, the median obtaining button 504b, and the mode obtaining button 504c are not included. The reason why the buttons 504a, 504b, 504c are not included is because the customer does not select the average, the median, or the mode, and the server 40 sets the standby time in the image forming apparatus 20 by determining the standby time with which the least energy consumption is estimated. Only for the setting for the first time, the server 40 sets the average as the standby time. In this way, it is possible to set the standby time with which the least energy consumption is estimated even if the customer does not select the standby time calculation method.

<Daily Energy Consumption Table Generation>

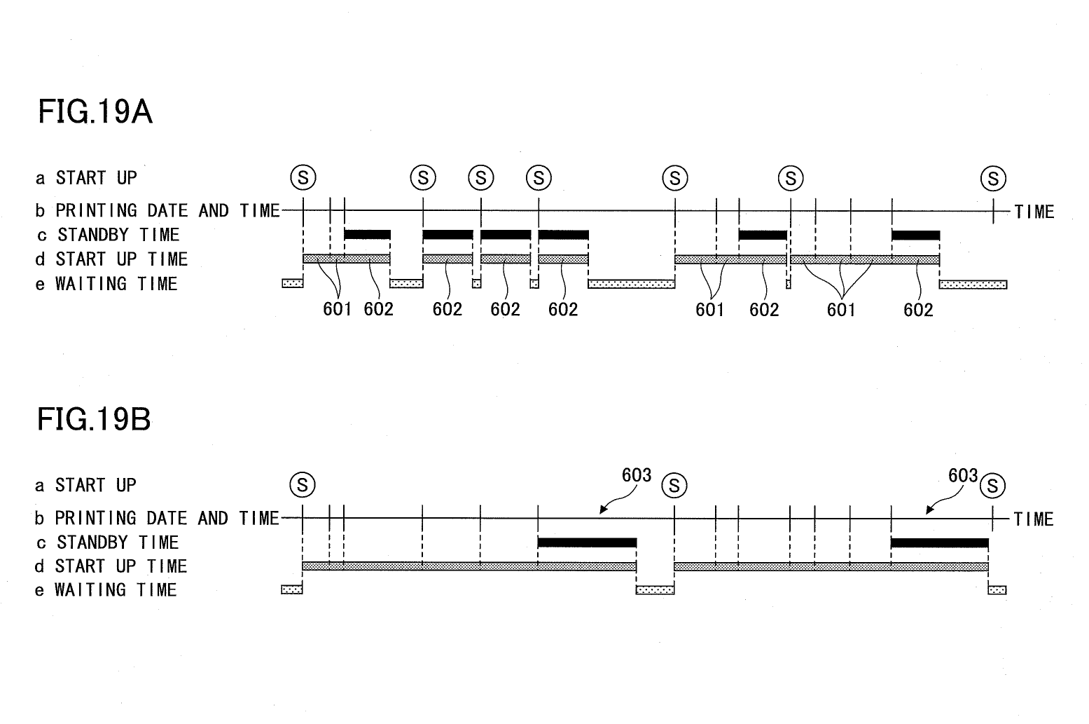

FIGS. 19A and 19B are examples of a drawing illustrating generation of the daily energy consumption table. In FIGS. 19A and 19B, “a. start up”, “b. printing-date-and-time”, “c. standby time”, “d. in-operation time”, and “e. waiting time” are indicated in the chronological manner. In the “a. start up”, “S”s are written at the timings of start up of the image forming apparatus 20. In the “b. printing-date-and-time”, vertical lines are written at the timings of printing by the customer. The “c. standby time” is the standby time set in the image forming apparatus 20. The “d. in-operation time” is the time when the image forming apparatus 20 is in operation. The “e. waiting time” is the time when the image forming apparatus 20 is waiting (or in an energy saving mode).

The energy is consumed at a start up, in in-operation time, and in waiting time. Therefore, energy consumption of a day is calculated as follows.

Energy consumption of a day=(energy consumption at a start up)×(the number of start-ups of the day)+(energy consumption in in-operation time)×(in-operation time of the day)+(energy consumption in waiting time)×(24 hours−in-operation time) formula (1)

The “in-operation time” will be described. The in-operation time includes a time difference between time of printing-date-and-time which does not require a start up of the image forming apparatus 20 and time of the previous printing-date-and-time (“601” in FIG. 19A) The above-described time difference between time of printing-date-and-time which does not require a start up of the image forming apparatus 20 and time of the previous printing-date-and-time does not include the in-operation time between time of the last printing-date-and-time before transitioning to a waiting state (energy saving mode) and time of transitioning to the waiting state. Therefore, taking into account the fact that the standby time must have elapsed before the starting up in the case where the image forming apparatus 20 starts up, the in-operation time between time of the last printing-date-and-time before transitioning to the waiting state and time of transitioning to the waiting state can be calculated by multiplying the number of start-ups by the standby time (“602” in FIG. 19A). In this way, the server 40 can calculate the in-operation time from the intermediate data table.

It is assumed that the standby time in FIG. 19A is the average, and the standby time in FIG. 19B is the mode (the average<the mode). As illustrated in FIG. 19B, the standby time is longer than the printing intervals except for two printing intervals 603, and thus, the image forming apparatus 20 goes into a waiting state only twice. As a result, it can be known that the number of start-ups is decreased. In this way, it is understood that the energy consumption of the image forming apparatus 20 changes significantly by changing the standby time.

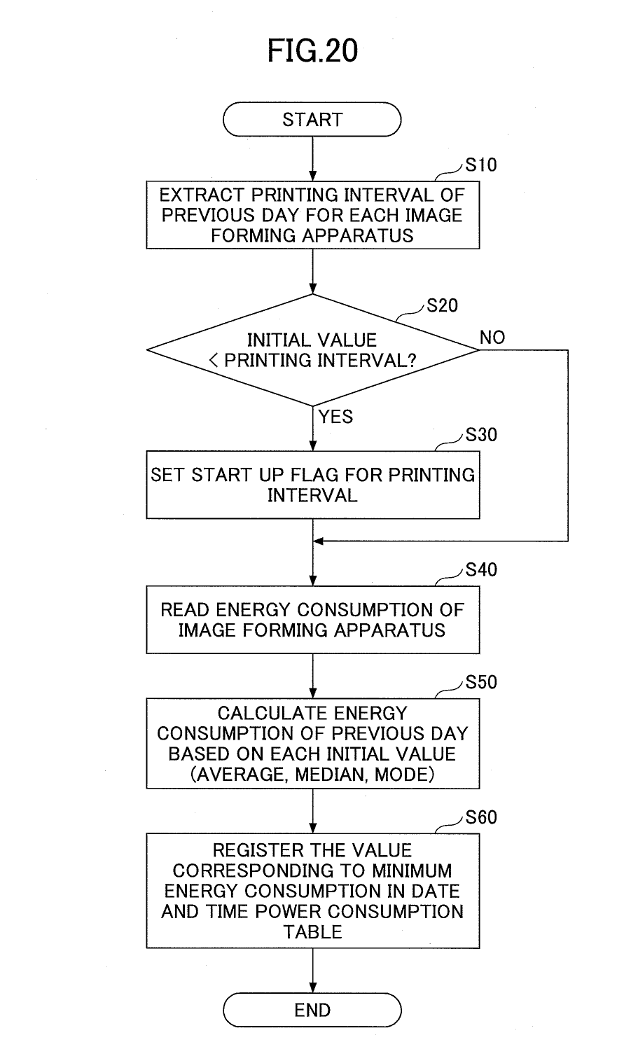

FIG. 20 is an example of a flowchart illustrating a procedure of calculating energy consumption by the energy consumption calculation unit 51 and registering in the daily energy consumption table. The process illustrated in FIG. 20 is performed, for example, once a day.

The energy consumption calculation unit 51 of the server 40 extracts printing intervals of the previous day for each image forming apparatus 20 (S10). In other words, the energy consumption calculation unit 51 reads the printing intervals of the records of the previous day taken out from the intermediate data table.

Next, the energy consumption calculation unit 51 determines whether the initial value is less than the printing interval for each record (S20). The initial value includes the average, the median, and the mode in the initial value data table. Therefore, the energy consumption calculation unit 51 performs the determination three times.

In the case where the initial value is less than the printing interval (YES in S20), it can be expected that the image forming apparatus 20 will start up, and thus, the energy consumption calculation unit 51 sets the start flag in the intermediate data table (S30). The determination is performed for each case of “printing interval and the average”, “printing interval and the median”, and “printing interval and the mode”, and the start flag is set for all cases which satisfy the condition in step S20.

Next, the energy consumption calculation unit 51 reads from the model energy consumption DB 4007 energy consumption of the image forming apparatus 20 associated with the model number (S40). The model number of the image forming apparatus 20 is included in the machine number.

The energy consumption calculation unit 51 calculates the energy consumption of the image forming apparatus 20 of the previous day by using the formula (1) (S50). In the intermediate data table, the start flag is set for each of the average, the median, and the mode. The energy consumption calculation unit 51 calculates the energy consumption of the previous day based on each of the average, the median, and the mode. Taking the intermediate data table illustrated in Table 10B as an example, the calculation method will be described in the case where the average is selected as the standby time. First, the number of start-ups in the case of the average is two. The in-operation time is 34 minutes calculated by adding “8 minutes+1 minutes+5 minutes” and “(the number of records in which the start flag is set=2)×(the average=10 minutes)”. Therefore, the energy consumption of the previous day in the case where the standby time is the average is as follows.

The energy consumption of the previous day (the average)=10 Wh×(the number of start-ups (2))+5 W×34 minutes+2 W×(24 hours−34 minutes)

The calculation is also performed for the median and the mode.

The energy consumption calculation unit 51 determines the smallest value of the energy consumption calculated by using the average, the energy consumption calculated by using the median, and the energy consumption calculated by using the mode, and registers the standby time with which the energy consumption is the smallest in the daily energy consumption table as the “standby time with which the energy consumption of the day is the smallest” (S60).

The “standby time with which the energy consumption of the day is the smallest” for each day of the month can be obtained by performing the calculation described above for each day of the month. Therefore, any one of the average, the median, and the mode is set in the “standby time with which the energy consumption of the day is the smallest” for each day of the month.

<Setting of Standby Time>

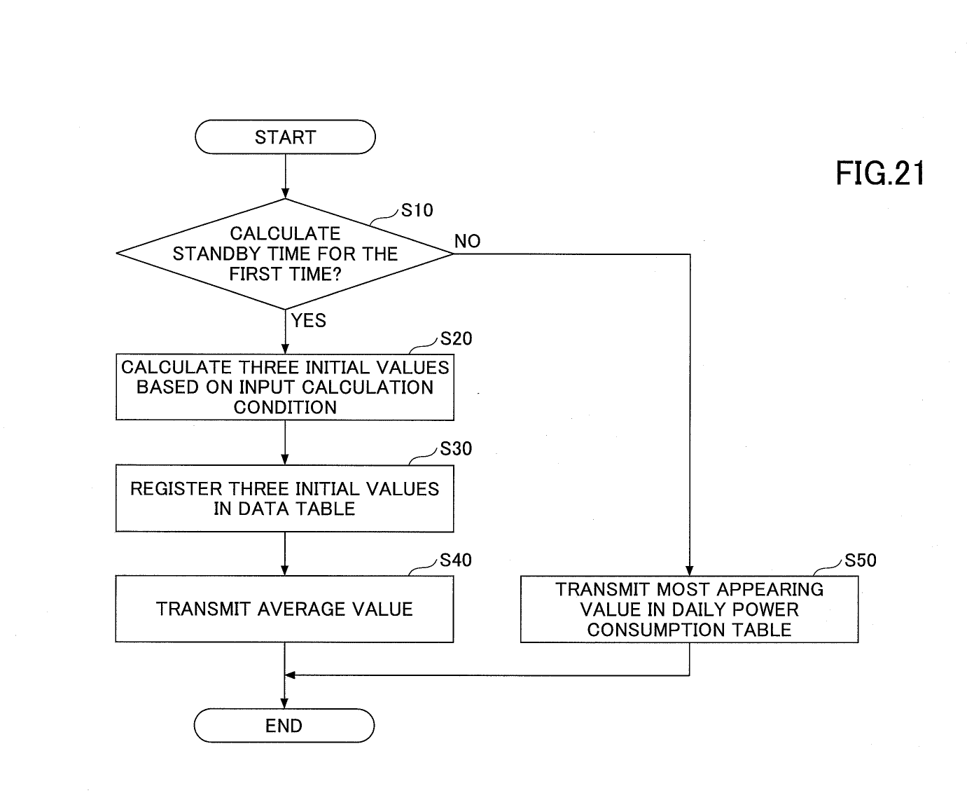

Referring to FIG. 21, setting of the standby time using the daily energy consumption table will be described. FIG. 21 is an example of a flowchart illustrating a procedure of setting an optimal standby time for the customer by the server 40. The procedure illustrated in FIG. 21 starts when the server 40 is requested to calculate the standby time from the administrator PC 60 or the image forming apparatus 20.

The time calculation unit 46 of the server 40 determines whether the calculation of the standby time is for the first time for the image forming apparatus 20 (S10). Whether the calculation of the standby time is for the first time can be determined by checking whether the machine number, the average, the median, and the mode is registered in the initial value data table.

In the case where the determination in step S10 is YES, similar to the embodiment 1, the server 40 calculates the initial value of the standby time based on the calculation condition set in the calculation condition setting screen 500 illustrated in FIG. 18 by the user (S20). In other words, by referring to the intermediate data table, the time calculation unit 46 calculates the average, the median, and the mode.

Next, the time calculation unit 46 registers the initial value (the average, the median, and the mode) in the initial value data table (S30).

The communication unit 41 of the server 20 transmits the average to the administrator PC 60 or the image forming apparatus 20 (S40). With the above operation, the initial value is set in the image forming apparatus 20 as the standby time. It should be noted that the communication unit 41 of the server 40 may transmits the median or the mode.

On the other hand, in the case where the determination in step S10 is NO, the storing and reading unit 49 of the server 40 reads from the daily energy consumption table the “standby time with which the energy consumption of the day is the smallest” associated with the machine number, and the communication unit 41 transmits the value which appears most to the administrator PC 60 or the image forming apparatus 20 (S50). Taking Table 9 as an example, 7 minutes, 10 minutes, 15 minutes, etc., are set, and thus, the most frequently appearing value is determined. It should be noted that the determined value may be the average or the median of the “standby times with which the energy consumption of the day is the smallest”.

Therefore, in the machine system 100 according to an embodiment, the standby time optimal for the printing intervals of the customer can be set without having the administrator select the value to be set in the image forming apparatus 20 from the average, the median, and the mode.

<Other Application>

As described above, preferable embodiments have been described. The present disclosure is not limited to the above-described embodiments. Various modifications and replacements may be possible in a range without departing from the spirit of the present disclosure.

For example, FIG. 5 is an example of a functional block diagram of the server 40 and the image forming apparatus 20, in which functions are divided according to main functions in order to facilitate understanding of processes performed by the server 40 and the image forming apparatus 20. The dividing method of the processes and names of the functions are not intended to limit the present disclosure. The processes of the server 40 and the image forming apparatus 20 may be further divided into smaller process units according to the content of the processes. Further, a process unit may be divided into further processes.

Further, the various kinds of databases stored in the storage unit 4000 in FIG. 5 and the various kinds of databases stored in the storage unit 2000 may exist on the network N.

Further, multiple servers 40 may be included in the machine system 100, and the functions of the server 40 may be distributed in multiple servers.

Further, in an embodiment, the server 40 calculates the standby time. The image forming apparatus 20 may calculate the standby time. In this case, the image forming apparatus 20 can calculate the standby time by storing the log data of the image forming apparatus 20.

The present invention is not limited to the specifically disclosed embodiments, and variations and modifications may be made without departing from the scope of the present invention.

What is claimed is:

1. An information processing apparatus capable of communicating with machines configured to operate in a first operation mode and in a second operation mode in which energy consumption is lower than the first operation mode via a network, the information processing apparatus comprising:
a processor configured to
obtain from the machines data sets including a use time information item generated every time the machines are used; and
generate time information used for transitioning from the first operation mode to the second operation mode by calculating differences between the use time information items of the data sets for each of the machines.

2. The information processing apparatus according to claim 1, the processor further configured to
transmit the generated time information to a second machine different from a first machine that has transmitted the data sets, or to the first machine.

3. The information processing apparatus according to claim 2, the processor further configured to
obtain extract condition information used for extracting the data sets used for the time information calculation from a terminal apparatus connected to the information processing apparatus via the network or from the first machine, wherein
the processor generates the time information by using the data sets extracted according to the obtained extract condition information.

4. The information processing apparatus according to claim 3, further comprising:
a memory,
wherein the processor further configured to
obtain first machine identification information;
read, from the memory in which at least one of size information, type of business information, and the number of users per machine of corresponding customers of the machines is associated with machine identification information of the machines and customer identification information of the customers, first customer identification information of a first customer associated with the first machine identification information obtained from the terminal apparatus or the first machine;
obtain as the extract condition information at least one of the size information, the type of business information, and the number of users per machine of the first customer of the first machine;
read second customer identification information of a second customer associated with the size information, the type of business information or the number of users comparable to the size information, the type of business information or the number of users of the first customer; and
generate the time information by using the data sets transmitted by the second machine used by the second customer of the second customer identification information.

5. The information processing apparatus according to claim 4, wherein
in the case where the extract condition information includes a condition to use only the data sets of the first customer, the processor reads from the memory the first customer identification information associated with the first machine identification information obtained from the terminal apparatus or the first machine, and generates the time information by using only the data sets transmitted by the first machine used by the first customer.

6. The information processing apparatus according to claim 4, wherein
the extract condition information includes an average, a median, or a mode as a calculation method of the time information, and
the processor calculates the time information by calculating the average, the median, or the mode of the differences of the use time information items according to the calculation method.

7. The information processing apparatus according to claim 4, wherein
the processor reads from the memory the customer identification information of the customer associated with the machine identification information added to the data sets, and associates the read customer identification information with the differences of the use time information items, and stores the associated result in data storage unit.

8. The information processing apparatus according to claim 7, wherein
in the data storage unit, the use time information items are associated with the customer identification information and the differences of the use time information items, and
the processor is further configured to delete the data sets whose use time information is old to a predetermined extent or older, in a range where the number of the differences of the use time information items associated with the customer identification information of a same customer is more than a predetermined number.

9. The information processing apparatus according to claim 8, wherein
the processor generates the time information day by day, and in the case where day of the time information generation is a weekday, a Saturday, a Sunday, or a public holiday, the processor generates the time information by using the data sets generated on a weekday, a Saturday, a Sunday, or a public holiday, respectively.

10. The information processing apparatus according to claim 6, the processor further configured to calculate the energy consumption based on the case where the machine transitions from the first operation mode to the second operation mode by using the corresponding time information items calculated according to the average, the median, and the mode of the differences of the use time information items, wherein
the processor transmits to the terminal apparatus or the first machine the time information item with which the least energy consumption of the energy consumptions is calculated.

11. The information processing apparatus according to claim 3, wherein
the processor generates the time information for each of time zones which are obtained by dividing a day into several zones.

12. The information processing apparatus according to claim 3, wherein
the processor transmits the time information to the first machine of the first machine identification information transmitted by the terminal apparatus, or transmits the time information to the first machine which has transmitted the extract condition information together with the first machine identification information.

13. An information processing system capable of communicating with machines configured to operate in a first operation mode and in a second operation mode in which energy consumption is lower than the first operation mode via a network, the information processing system comprising:
a transmission unit of each of the machines configured to transmit data sets including use time information items generated every time the machine is used;
a data obtaining unit configured to obtain the data sets; and
a time information generation unit configured to generate time information for transitioning from the first operation mode to the second operation mode by calculating differences between the use time information items of the data sets.

14. An information processing method performed by an information processing system capable of communicating with machines configured to operate in a first operation mode and in a second operation mode in which energy consumption is lower than the first operation mode via a network, the information processing method comprising:
transmitting, by a transmission unit, data sets including use time information items generated every time each of the machines is used;
obtaining, by a data obtaining unit, the data sets; and
generating, by a time information generation unit, time information for transitioning from the first operation mode to the second operation mode by calculating differences between the use time information items of the data sets for each of the machines.
